(19) United States
(12) Patent Application Publication
(10) Pub. No.: US 2026/0098978 A1
(43) Pub. Date: Apr. 9, 2026

(54) SYSTEMS AND METHODS FOR AUTOMATICALLY DETECTING SAND EVENTS IN WELL SYSTEMS

(71) Applicant: BP Exploration Operating Company Limited, Middlesex (GB)

(72) Inventor: Ruairi Dunne, London (GB)

(73) Assignee: BP Exploration Operating Company Limited, Middlesex (GB)

(21) Appl. No.: 19/291,773

(22) Filed: Aug. 6, 2025

Related U.S. Application Data
(60) Provisional application No. 63/705,109, filed on Oct. 9, 2024.

(51) Int. Cl. G01V 1/50; E21B 49/08

(52) U.S. Cl. CPC G01V 1/50; E21B 49/08

(57) ABSTRACT

A method for detecting a sand event in a well system includes receiving by a sand detection system one or more acoustic datastreams, wherein the one or more acoustic datastreams are provided by one or more corresponding acoustic sensors of the well system, subjecting by the sand detection system the one or more acoustic datastreams to a plurality of separate tests each providing an independent test score correlated with a probability of the one or more acoustic datastreams tested by a sand module of the sand detection system capturing the sand event, and combining by a scoring module of the sand detection system the one or more test scores to produce an overall sand score indicative of the probability of the one or more acoustic datastreams tested by the sand detection system capturing the sand event.

### CROSS-REFERENCE TO RELATED APPLICATIONS

This application claims benefit of U.S. provisional patent application Ser. No. 63/705,109 filed Oct. 9, 2024, and entitled “Systems and Methods for Automatically Detecting Sand Events in Well Systems,” which is hereby incorporated herein by reference in its entirety for all purposes.

### STATEMENT REGARDING FEDERALLY SPONSORED RESEARCH OR DEVELOPMENT

Not applicable.

### BACKGROUND

Sand production is a pervasive issue in well systems, particularly in well systems utilized in the production of hydrocarbons from a subsurface region. Sand may be produced from a wellbore of a well system (e.g., in a stream or flow of hydrocarbons and/or other formation materials) when, for example, unconsolidated or poorly consolidated formations of the subsurface region positioned around the wellbore disintegrate under the stress of production, leading to the migration of sand into the wellbore along with the produced formation fluids. Sand production in well systems may cause a multitude of operational challenges including, for instance, equipment abrasion, clogging of fluid conduits, reduction in production efficiency of the well system, and potentially catastrophic failures of downhole and surface equipment of the well system.

### SUMMARY

An embodiment of a method for detecting a sand event in a well system comprises (a) receiving by a sand detection system one or more acoustic datastreams provided by one or more corresponding acoustic sensors of the well system, (b) subjecting by a sand module of the sand detection system the one or more acoustic datastreams to one or more predefined sand tests wherein each of the one or more sand tests produces a sand test score that is positively correlated with a probability of the one or more acoustic datastreams tested by the sand module capturing the sand event, (c) subjecting by a noise module of the sand detection system the one or more acoustic datastreams to one or more predefined noise tests wherein each of the one or more noise tests produces a noise test score that is negatively correlated with the probability of the one or more acoustic datastreams tested by the noise module capturing the sand event, and (d) relating by a scoring module of the sand detection system the one or more sand test scores produced by the sand module with the one or more noise test scores produced by the noise module to produce an overall sand score indicative of the probability of the one or more acoustic datastreams tested by the sand detection system capturing the sand event. In some embodiments, (d) comprises inputting the one or more sand test scores and the one or more noise test scores to an activation function that produces as an output the overall sand score. In some embodiments, each of the one or more sand tests are indicative of the occurrence of the sand event in the one or more acoustic datastreams tested by the sand module, and each of the one or more noise tests are indicative of one or more noise events in the one or more acoustic datastreams tested by the noise module. In certain embodiments, the one or more sand tests comprises at least one of an anomaly detection test and a positive skew detection test. In certain embodiments, (d) comprises inputting the one or more sand test scores to an activation function that produces as an output the overall sand score. In some embodiments, the one or more noise tests comprises at least one of a baseline jump detection test, a data fitness test, a homogeneity detection test, a bimodal test, a well similarity detection test, and a choke stability test. In some embodiments, the baseline jump detection test produces a baseline jump score that is based on a sequential modality and a post-jump stability of the one or more acoustic datastreams tested by the noise module. In certain embodiments, the data fitness test produces a data fitness score that is based on missing values within the one or more acoustic datastreams tested by the noise module.

An embodiment of a method for detecting a sand event in a well system comprises (a) receiving by a sand detection system one or more acoustic datastreams, wherein the one or more acoustic datastreams are provided by one or more corresponding acoustic sensors of the well system, (b) subjecting by the sand detection system the one or more acoustic datastreams to a plurality of separate tests each providing an independent test score correlated with a probability of the one or more acoustic datastreams tested by a sand module of the sand detection system capturing the sand event, and (c) combining by a scoring module of the sand detection system the one or more test scores to produce an overall sand score indicative of the probability of the one or more acoustic datastreams tested by the sand detection system capturing the sand event. In certain embodiments, (c) comprises inputting the one or more test scores to an activation function that produces as an output the overall sand score. In some embodiments, the one or more tests comprises at least one of an anomaly detection test and a positive skew detection test. In some embodiments, the anomaly detection test produces an anomaly score that is based on a comparison between a selected window of the one or more acoustic datastreams and a baseline of the one or more acoustic datastreams. In certain embodiments, the positive skew detection test produces a skew score that is based on a relationship between a spike and a decay of a selected window of the one or more acoustic datastreams. In certain embodiments, (c) comprises inputting the anomaly score and the positive skew score to an activation function that produces as an output the overall sand score. In some embodiments, the one or more tests comprises at least one of a baseline jump detection test, a data fitness test, a homogeneity detection test, a bimodal test, a well similarity detection test, and a choke stability test. In some embodiments, the homogeneity detection test produces a homogeneity similarity score that is based on a frequency spectrum of a Fourier transformed datastream obtained from the one or more acoustic datastreams. In certain embodiments, the bimodal test produces a bimodal score that is based on the magnitude of a difference between at least one of an upper quartile of the one or more acoustic datastreams and a baseline of the one or more acoustic datastreams, the baseline and a lower quartile of the one or more acoustic datastreams, and the upper quartile and the lower quartile. In certain embodiments, the well similarity detection test produces a neighboring well similarity score that is based on a similarity between the one or more acoustic datastreams and one or more neighboring acoustic datastreams of one or more neighboring wellsites that are time-synced with the one or more acoustic datastreams. In some embodiments, the choke stability test produces a choke stability score that is based on a comparison between the one or more acoustic datastreams and a choke position datastream provided by a choke position sensor of the well system.

An embodiment of a system comprises one or more processors, and one or more storage devices coupled to the one or more processors, the one or more storage devices configured to store instructions that, when executed by the one or more processors, configure the one or more processors to (a) receive by a sand detection system one or more acoustic datastreams, wherein the one or more acoustic datastreams are provided by one or more corresponding acoustic sensors of a well system, (b) subject by the sand detection system the one or more acoustic datastreams to a plurality of separate tests each providing an independent test score correlated with a probability of the one or more acoustic datastreams tested by a sand module of the sand detection system capturing a sand event, and (c) combine by a scoring module of the sand detection system the one or more test scores to produce an overall sand score indicative of the probability of the one or more acoustic datastreams tested by the sand detection system capturing the sand event.

### BRIEF DESCRIPTION OF THE DRAWINGS

For a detailed description of various exemplary embodiments, reference will now be made to the accompanying drawings in which:

FIG. 1 is a schematic view of an exemplary well system in accordance with principles disclosed herein;

FIG. 2 is a flowchart of an exemplary method for administering an anomaly test in accordance with principles disclosed herein;

FIG. 3 is a graph depicting an exemplary acoustic sound detector (ASD) acoustic datastream in accordance with principles disclosed herein;

FIG. 4 is a graph depicting an exemplary ASD standard deviation datastream in accordance with principles disclosed herein;

FIG. 5 is a graph depicting an exemplary ASD anomaly percentile datastream in accordance with principles disclosed herein;

FIG. 6 is a graph depicting another exemplary ASD acoustic datastream in accordance with principles disclosed herein;

FIG. 7 is a graph depicting another exemplary ASD anomaly percentile in accordance with principles disclosed herein;

FIG. 8 is a graph depicting an exemplary ASD anomaly multiplier datastream in accordance with principles disclosed herein;

FIG. 9 is a block diagram depicting an exemplary anomaly detection system in accordance with principles disclosed herein;

FIG. 10 is a flowchart depicting an exemplary method for administering a positive skew detection test in accordance with principles disclosed herein;

FIG. 11 is a graph depicting an exemplary ASD acoustic datastream in accordance with principles disclosed herein;

FIG. 12 is a graph depicting an exemplary synthetic skew curves in accordance with principles disclosed herein;

FIG. 13 is a graph depicting an exemplary positive skew score in accordance with principles disclosed herein;

FIG. 14 is a block diagram depicting an exemplary positive skew detection system in accordance with principles disclosed herein;

FIG. 15 is a flowchart depicting an exemplary method for administering a baseline jump detection test in accordance with principles disclosed herein;

FIG. 16 is a graph depicting an exemplary ASD acoustic datastream in accordance with principles disclosed herein;

FIGS. 17A and 17B are graphs each depicting an exemplary set of data points in accordance with principles disclosed herein;

FIGS. 18A and 18B are graphs each depicting an exemplary set of data points in accordance with principles disclosed herein;

FIG. 19 is a graph depicting an exemplary baseline jump score in accordance with principles disclosed herein;

FIG. 20 is a block diagram depicting an exemplary baseline jump detection system in accordance with principles disclosed herein;

FIG. 21 is a flowchart depicting an exemplary method for administering a data fitness test in accordance with principles disclosed herein;

FIG. 22 is a graph depicting an exemplary ASD acoustic datastream in accordance with principles disclosed herein;

FIG. 23 is a graph depicting an exemplary value fitness score in accordance with principles disclosed herein;

FIG. 24 is a graph depicting an exemplary zero value score in accordance with principles disclosed herein;

FIG. 25 is a graph depicting an exemplary missing value score and an exemplary zero value score in accordance with principles disclosed herein;

FIG. 26 is a graph depicting an exemplary data fitness score in accordance with principles disclosed herein;

FIG. 27 is a block diagram depicting an exemplary data fitness testing system in accordance with principles disclosed herein;

FIG. 28 is a flowchart depicting an exemplary method for administering a homogeneity detection test in accordance with principles disclosed herein;

FIG. 29 is a graph depicting an exemplary ASD acoustic datastream in accordance with principles disclosed herein;

FIG. 30 is a graph depicting an exemplary selected time window in accordance with principles disclosed herein;

FIG. 31 is a graph depicting an exemplary ASD frequency curve in accordance with principles disclosed herein;

FIG. 32 is a graph depicting an exemplary homogeneity similarity score in accordance with principles disclosed herein;

FIG. 33 is a block diagram depicting an exemplary homogeneity detection system in accordance with principles disclosed herein;

FIG. 34 is a flowchart of an exemplary method for administering an energetic bimodality detection test in accordance with principles disclosed herein;

FIG. 35 is a graph depicting an exemplary ASD acoustic datastream in accordance with principles disclosed herein;

FIG. 36 is a graph depicting exemplary upper and lower gap datastreams in accordance with principles disclosed herein;

FIG. 37 is a graph depicting an exemplary energy score in accordance with principles disclosed herein;

FIG. 38 is a histogram depicting an exemplary kernel density in accordance with principles disclosed herein;

FIG. 39 is a graph depicting an exemplary ASD acoustic datastream in accordance with principles disclosed herein FIG. 40 is a graph depicting an exemplary bimodality score in accordance with principles disclosed herein;

FIG. 41 is a graph depicting an energetic bimodality score in accordance with principles disclosed herein;

FIG. 42 is a block diagram depicting an exemplary energetic bimodality detection system in accordance with principles disclosed herein;

FIG. 43 is a flowchart depicting an exemplary method for administering an offset well similarity detection test in accordance with principles disclosed herein;

FIG. 44 is a graph depicting exemplary ASD acoustic datastreams in accordance with principles disclosed herein;

FIGS. 45-47 are graphs depicting an exemplary normalized acoustic datastreams in accordance with principles disclosed herein;

FIG. 48 is a graph depicting an exemplary offset well similarity score in accordance with principles disclosed herein;

FIG. 49 is a block diagram depicting an exemplary offset well similarity detection system in accordance with principles disclosed herein;

FIG. 50 is a flowchart depicting an exemplary method for administering a choke instability detection test in accordance with principles disclosed herein;

FIG. 51 is a graph depicting an exemplary ASD acoustic datastream in accordance with principles disclosed herein;

FIG. 52 is a graph depicting an exemplary choke position in accordance with principles disclosed herein;

FIG. 53 is a graph depicting an exemplary choke instability score in accordance with principles disclosed herein;

FIG. 54 is a block diagram depicting an exemplary choke instability detection system in accordance with principles disclosed herein;

FIG. 55 is a graph depicting an exemplary ASD acoustic datastream in accordance with principles disclosed herein;

FIG. 56 is a graph depicting an exemplary overall sand score in accordance with principles disclosed herein;

FIG. 57 is a block diagram of an exemplary sand detection system in accordance with principles disclosed herein;

FIG. 58 is a graph depicting an exemplary ASD anomaly multiplier in accordance with principles disclosed herein;

FIG. 59 is a graph depicting an exemplary ASD anomaly percentile in accordance with principles disclosed herein;

FIG. 60 is a graph depicting an exemplary positive skew score in accordance with principles disclosed herein;

FIGS. 61 and 62 are graphs depicting the response of an activation function to adjustments to inputs thereof in accordance with principles disclosed herein;

FIG. 63 is a block diagram depicting an exemplary sand detection system in accordance with principles disclosed herein;

FIG. 64 is a block diagram of an embodiment of a computer system in accordance with principles described; and

FIGS. 65 and 66 are flowcharts depicting embodiments of methods for detecting a sand event in a well system in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment. Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, effective management and mitigation of sand production may be critical to the operational efficiency and economic viability of well systems in at least some applications. Conventionally, strategies to manage sand production in well systems often involve either mechanical filtering techniques and/or chemical consolidation methods. Particularly, physical filters or other barriers may be provided in the wellbore of the well system such as, for example, gravel packs, screens, slotted liners and the like designed to allow the production of formation fluids from the wellbore while filtering out sand particles. For instance, gravel packing is a widely used technique for managing sand production from a wellbore where a slurry of gravel is pumped into the wellbore to form a permeable barrier that supports the formation to thereby limit the production of sand from the wellbore. However, these conventional mechanical techniques have limitations such as the potential for screenout, plugging, gravel pack failure, and/or other issues reducing the production of formation fluids from the wellbore. In other words, the use of physical barriers, while capable of filtering out some sand for a period of time, may result in a reduction in the production of formation fluids from the wellbore over time as sand and other materials collect in or along the physical barrier.

In addition, conventional chemical consolidation techniques involve injecting chemicals (e.g., resins, polymers and the like) into the subsurface region surrounding the wellbore to bind the various sand grains together into larger particles to thereby reducing their mobility such that the production of sand from the wellbore may be minimized or otherwise managed. However, chemical consolidation techniques can also alter reduce the permeability of the subsurface region resulting in reduced production rates. Additionally, the long-term stability of these chemical treatments is not a given, particularly in harsh downhole environments where temperatures and pressures can be extreme. Thus, such conventional chemical consolidation techniques may lessen in their efficacy over time due to degradation of the chemicals in situ. Given the limitations of conventional mechanical and chemical sand management techniques, managing sand production remains a significant challenge, particularly in well systems with high flow rates or in formations that are highly unconsolidated.

One emerging technology for monitoring sand production in well systems is the use of surface acoustic sand detectors (ASDs). These devices are designed to detect the acoustic signals generated by sand particles entrained in the production stream as or following its discharge from the wellbore. For instance, ASDs may acoustically detect sand particles impacting the production tubing or other equipment (e.g., an internal probe of the ASD). Particularly, when sand particles are produced along with formation fluids in the production stream of the well system, they can create high-frequency (HF) acoustic signals as a result of striking the different (metallic) internal surfaces of surface equipment of the well system. ASDs include one or more acoustic sensors for detecting these HF acoustic signals. Additionally, ASDs are typically installed on the surface, where they may monitor the acoustic signals from a wellhead, fluid conduits such as production flowlines, and/or other surface equipment to provide real-time or near real-time acoustic data pertaining to the production stream passing through the ASD. One advantage of ASDs is their ability to provide continuous, real-time monitoring of sand production without the need for downhole sensors or complex instrumentation, making ASDs a relatively low-cost and non-invasive option for sand monitoring.

However, ASDs currently suffer from limitations that limit their applicability. As an example, the accuracy of sand detection can be affected by various factors, such as background noise, flow conditions, and the properties of the formation fluids contained in the production stream. Given the presence of such noise and other confounding factors, the acoustic data generated by ASDs used for sand monitoring in well systems may be difficult to interpret (particularly in liquid environments), thus limiting the usefulness of the acquired acoustic data in determining the presence (along with the amount) of sand being produced in the production stream of the well system.

Accordingly, embodiments disclosed herein include systems and methods for efficiently and quickly (e.g., in real- or near real-time) detecting the occurrence of a sand event in a well system by subjecting an acoustic datastream captured by an ASD to one or more predefined tests that ultimately produce an overall sand score indicative of the occurrence of the sand event. Particularly, the one or more predefined tests may produce or determine one or more corresponding test scores that are related together in order to determine the overall sand score. In some embodiments, the predefined tests are divided into two separate classes: sand score tests where a positive result is indicative of the occurrence of a sand event, and noise score tests where a positive result is, conversely, not indicative of the occurrence of a sand event and instead may indicate the occurrence of a non-sand noise vent. In certain embodiments, the different test scores are provided as inputs to an activation function to, for example, introduce nonlinearity into the overall sand score while also allowing for the tuning of the various inputs and of the parameters of the activation function itself (e.g., in the form of one or more tuning parameters) to maximize the accuracy in detecting sand events.

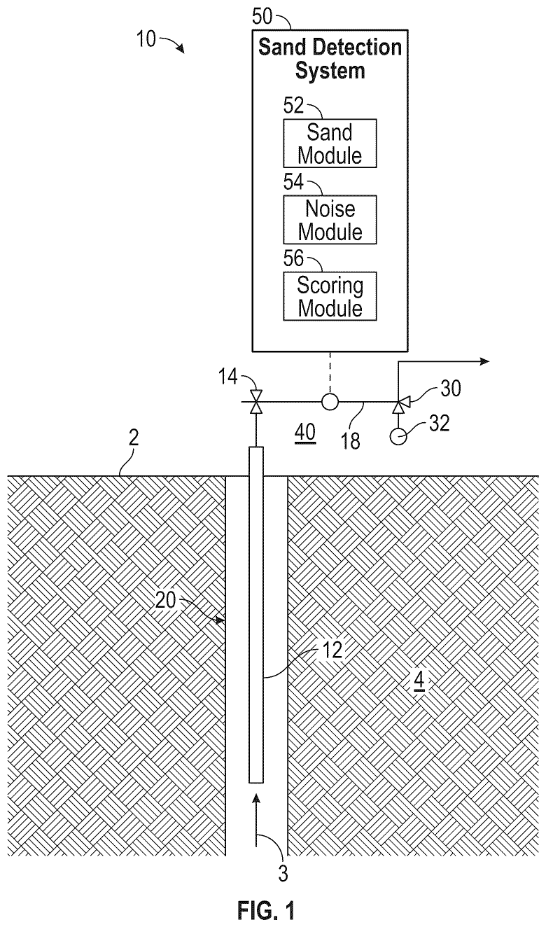

Referring now to FIG. 1, an embodiment of a well system 10 located at a wellsite 1 at which a wellbore 20 of the well system 10 is physically located. Particularly, in this exemplary embodiment, well system 10 is configured for producing hydrocarbons from a subsurface region 4 (e.g., an earthen subterranean formation) using the wellbore 20 that extends into or penetrates the subsurface region 4 from a surface 2 (e.g., a terranean surface) thereof. In other embodiments, well system 10 perform other functions whereby materials from subsurface region 4 are produced at the surface 2 via wellbore 20. In this exemplary embodiment, well system 10 generally includes production tubing 12 extending within the wellbore 20, a surface production valve 14 (e.g., constant pressure valve), a packer assembly 16, a fluid conduit or production flowline 18, a production choke 30, and a computer-implemented sand detection system 50. Well system 10 may also include any suitable equipment for supporting or facilitating transportation of fluids, tools, and other materials into and from the wellbore 20 (e.g., a wellhead, one or more pumps, hydrocarbon production equipment such as separators, dehydrators, and the like). Additionally, in this exemplary embodiment, well system 10 includes a choke sensor 32 coupled to the production choke 30 and configured to measure or monitor one or more parameters of the production choke 30 including, for example, fluid flowrate, fluid pressure, and choke position (e.g., between a fully open and a fully closed position of production choke 30).

Surface 2 may comprise an earthen land surface, a sub-sea surface (e.g., a seabed), or other underwater surfaces. As shown in FIG. 1, wellbore 20 extends from an uphole end thereof located at surface 2, into the subsurface region 4 along a longitudinal axis to an opposing downhole end located within subsurface region 4. In this configuration, wellbore 20 provides access to hydrocarbons or other formation fluids in the subsurface region 4. While wellbore 20 is shown in FIG. 1 as substantially vertical, it should be appreciated that in other embodiments wellbore 20 may be deviated and extend at an incline relative to the direction of gravity along one or more sections of the deviated wellbore. Additionally, wellbore 20 may be formed with various dimensions (e.g., diameter, depth). It may also be understood that wellbore 20 is formed using a drilling system not shown in FIG. 1 which may include, among other things, a support structure (e.g., a derrick, a mast) located at the surface 2, and a drilling assembly deployable into the subsurface region 4 including a drill bit for cutting into the subsurface region 4 and which is coupled to a downhole end of a drill string suspended from the surface support structure.

In some embodiments, wellbore 20 may be cased or lined by a casing string secured to a generally cylindrical sidewall of wellbore 20 via cement or any other suitable material that has been pumped into the annulus formed between an outer surface of the casing string and the sidewall of wellbore 20. Additionally, the Casing string may be perforated at certain locations along its longitudinal length to facilitate the flow of fluids in and out of the subsurface region 4 into the wellbore 20.

Production tubing 12 of the well system 10 is installed within wellbore 20 and extends axially from a first or uphole end located at or proximate to surface 2 to a second or downhole end located within subsurface region 4. Production tubing 12 provides a fluid conduit for production fluids (e.g., hydrocarbons, water, and other fluids) from subsurface region 4 along with potentially other formation materials (e.g., sand and other particles) to flow from the subsurface region 4 to the surface 2 along a fluid production stream or flowpath 3 that may enter the production tubing 12 at a downhole end thereof. Production tubing 12 may be centralized and secured in the wellbore 20 via a tubing hanger coupled to a support structure (e.g., a wellhead and the like) disposed at the surface 2. In this configuration, an annulus may be formed in the wellbore 20 extending radially between a sidewall of the wellbore 20 (or a casing string lining the wellbore 20) and the production tubing 12. In some embodiments, production tubing 12 may comprise a plurality of steel tubing joints that are coupled end-to-end and installed within wellbore 20.

Production valve 14 of the well system 10 may be installed at the surface 2 proximate the wellhead or at other surface locations (e.g., along production flowline 18). Production valve 14 may be used to isolate a central passage of production tubing 12 from the external environment at the surface 2 and control the flow of production stream 3 produced from wellbore 20. Additionally, production choke 30 is located downstream from production valve 14 along production stream 3 and is configured to regulate the downhole flow of production stream 3 into the production tubing 12 (e.g., via the selectable application of backpressure to the downhole flow of production stream 3) and maintain the pressure in production tubing 12 at a desired downhole pressure regardless of changes or fluctuations in the wellbore 20 (e.g., changes in production rate).

In addition, well system 10 includes one or more acoustic sensors or ASDs 40 for acquiring acoustic signals or data from the production stream 3 as it flows through the well system 10. Particularly, in this exemplary embodiment, well system 10 includes one or more surface ASDs 40 positioned along the production flowline 18 of well system 10. The number and positioning of ASDs 40 may vary from the configuration shown in the embodiment illustrated in FIG. 1. For instance, ASD 40 may be conveniently clamped to the production flowline 18 whereby ASD 40 may continually acquire (e.g., based on a sample rate of the ASD 40) acoustic signals from the production stream 3 as it flows through the production flowline 18.

The sand detection system 50 is in signal communication with the ASD 40 and thus may acquire the acoustic signals captured by ASD 40. Particularly, sand detection system 50 is configured to receive one or more acoustic datastreams provided by the one or more ASDs 40 of well system 10. For instance, in some embodiments, a wired or wireless signal connection (e.g., an electrical connection) may connect ASD 40 with sand detection system 50 whereby acoustic signals captured by ASD 40 are transmitted as an acoustic datastream to sand detection system 50 in real-time or near real-time. Sand detection system 50 may be located at the wellsite 1 or offsite at a remote location and in signal communication with ASD 40 via one or more wireless networks connected therebetween. In other embodiments, the acoustic datastream may be logged or saved by ASD 40 and provided to the sand detection systems 50 in batches. These batches may be provided periodically (e.g., hourly batches, daily batches, weekly batches, monthly batches), in response to a triggering or threshold event, or via other mechanisms.

As will be described further herein, sand detection system 50 is generally configured to monitor or detect a sand event in the well system 10. As used herein, the term “sand event” is defined as meaning the incursion of at least some subsurface sand in a fluid stream (e.g., a production stream) produced from a wellbore of a well system. In this exemplary embodiment, sand detection system 50 generally includes a pair of computer-implemented testing modules including a sand module 52 and a noise module 54. As will be described further herein, sand module 52 is generally configured to subject the one or more acoustic datastreams received by sand detection system 50 from ASD 40 to one or more predefined sand tests while the noise module 54 is configured to subject the one or more acoustic datastreams received by sand detection system 50 from ASD 40 to one or more predefined noise tests.

In some embodiments, each of the one or more sand tests administered by the sand module 52 produces a sand test score that is positively correlated with a probability of one or more acoustic datastreams subjected to the one or more sand tests capturing a sand event in the well system 10. In other words, the greater in magnitude the sand test score, the more likely it is that the acoustic datastream captured by ASD 40 and tested by the sand test captured an actual or real sand event in the well system 10. In certain embodiments, the sand test scores of the one or more sand tests administered by sand module 52 is indicative of the occurrence of a sand event in the one or more acoustic datastreams subjected to the one or more sand tests.

In certain embodiments, the one or more sand tests administered by sand module 52 include at least one of an anomaly detection test and a positive skew detection test. As an example, the anomaly detection test may produce an anomaly score that is based on a comparison between a selected window of the one or more acoustic datastreams captured by ASD 40 and a baseline of the one or more acoustic datastreams. As another example, the positive skew detection test may produce a skew score that is based on a relationship between a spike and a decay of a selected window of the one or more acoustic datastreams captured by ASD 40.

Conversely, in certain embodiments, each of the one or more noise tests administered by the noise module 54 produces a noise test score that is negatively correlated with a probability of the one or more acoustic datastreams tested by noise module 54 capturing a sand event in the well system 10. For instance, a noise having a significantly great magnitude indicates that a potential sand event detected by sand detection system 50 (e.g., by sand module 52) may, instead of accurately detecting an actual sand event in well system 10, may instead be a false positive with the one or more acoustic datastreams failing to capture an actual sand event. To state in other words, the one or more noise tests are each not indicative of the occurrence of a sand event in the one or more acoustic datastreams subjected to the one or more noise tests.

In some embodiments, each of the one or more noise tests administered by noise module 54 are indicative of the occurrence of one or more noise events in the one or more acoustic datastreams tested subjected to the one or more noise tests. As used herein, the terms “noise event” and “noise feature” are defined as meaning a predefined pattern detectable in acoustic datastreams caused by phenomena of a well system other than the occurrence of a sand event in the well system. In certain embodiments, the one or more noise tests includes at least one of a baseline jump detection test, a data fitness test, a homogeneity detection test, a bimodal test, a well similarity detection test, and a choke stability test.

In some embodiments, sand detection system 50 may include only a single testing module rather than both sand module 52 and noise module 54. In such an embodiment, sand detection system 50 may be configured to subject one or more acoustic datastreams captured by ASD 40 to a plurality of separate or independent tests. The plurality of separate tests would each provide an independent test score correlated with a probability of the one or more acoustic datastreams subjected to the plurality of separate tests capturing a sand event in the well system 10.

In this exemplary embodiment, in addition to the testing modules of sand module 52 and noise module 54, sand detection system 50 includes a computer-implemented scoring module 56 configured to relate outputs of the sand module 52 with outputs of the noise module 54 in order to detect the occurrence of a sand event in the well system 10 based on the acoustic datastream collected by ASD 40. As used herein, the term “relate” and “relating” in the context of relating a first variable to a second variable is defined as including any form of comparison or combination of the first and second variables whereby a third variable is obtained that is based on both the first and second variables. As an example, in certain embodiments, scoring module 56 is configured to relate the one or more sand test scores with the one or more noise test scores to produce an overall sand score indicative of the probability of the one or more acoustic datastreams subjected to the one or more sand tests and the one or more noise tests capturing a sand event in well system 10.

In some embodiments, scoring module 56 produces, based on outcomes of both the one or more sand tests and the one or more noise tests, an overall sand score indicative of the probability of the one or more acoustic datastreams subjected to the one or more sand tests and the one or more noise tests capturing a sand event in well system 10. In certain embodiments, the scoring module combines the one or more sand test scores and the one or more noise test scores (or simply the plurality of separate tests for embodiments of sand detection system 50 including only a single testing module) to produce the overall sand score. In certain embodiments, the scoring module instead compares the one or more sand test scores and the one or more noise test scores (or simply the plurality of separate tests) to produce the overall sand score.

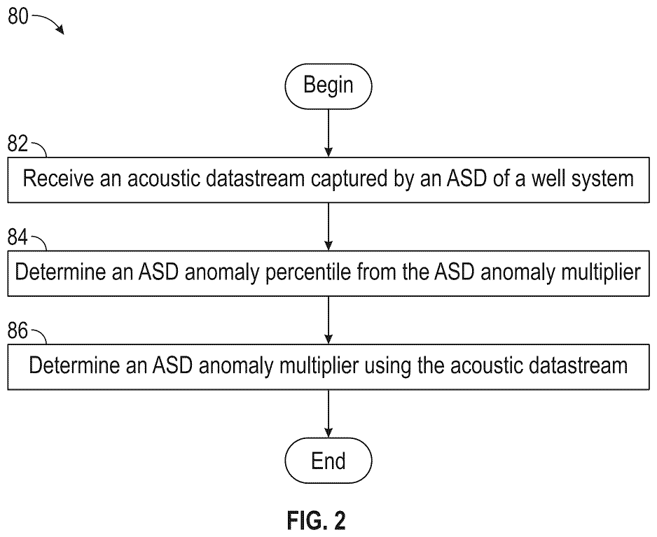

As described above, in some embodiments, the one or more sand tests administered by sand module 52 comprises an anomaly detection test which is generally configured to detect periods or patterns of anomalous acoustic signals (captured in the one or more acoustic datastreams) associated with a sand event in well system 10. For example, and referring to FIGS. 2-7, FIG. 2 depicts an embodiment of a method 80 for administering an anomaly test, and which may also be referred to herein as anomaly detection test 80. In some embodiments, the anomaly detection test 80 may be administered by the sand detection system 50 shown in FIG. 1 including, for example, by the sand module 52 of sand detection system 50.

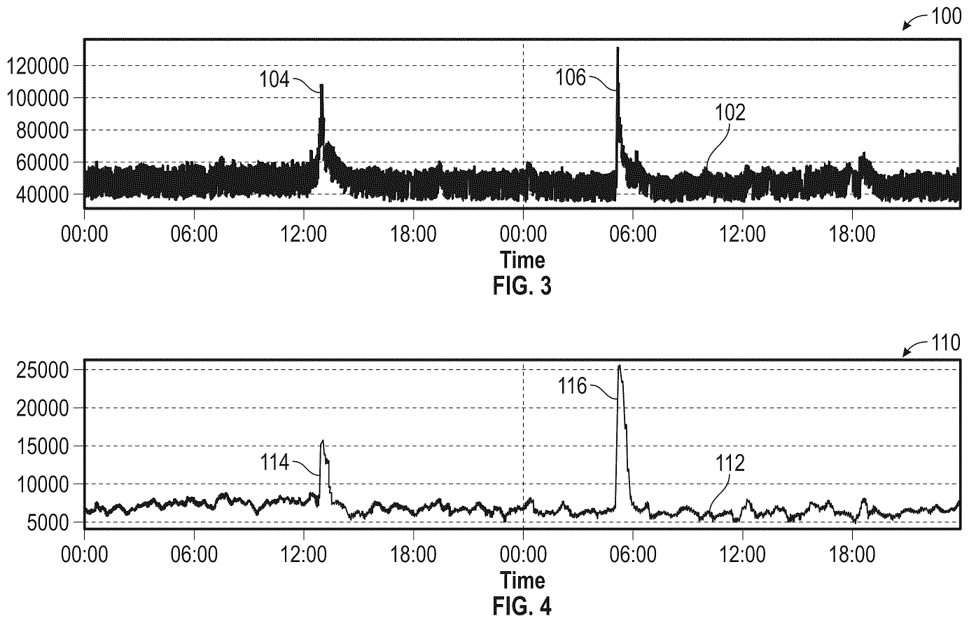

Beginning at block 82, anomaly detection test 80 includes receiving an acoustic datastream captured by an ASD (e.g., ASD 40 shown in FIG. 1) of a well system (e.g., well system 10 shown in FIG. 1). For instance, FIG. 3 depicts a graph 100 depicting an exemplary ASD acoustic datastream 102 captured by an ASD such as the ASD 40 of well system 10 shown in FIG. 1. In certain embodiments, block 82 includes receiving an acoustic datastream similar to the ASD acoustic datastream 102 shown in FIG. 3. Particularly, graph 100 plots the ASD acoustic datastream 102 in nondimensional units or “counts” (e.g., obtained from raw acoustic signals) presented along the Y-axis of graph 100 as a function of time (presented in hours along the X-axis of graph 100). In this example, the ASD acoustic datastream 102 includes a pair of spikes 104 and 106 occurring at different points in time. In certain embodiments, ASD acoustic datastream 102 comprises a raw or unfiltered output of a given ASD. The raw or unfiltered output obtained from an ASD may also be referred to herein simply as an ASD acoustic datastream. In some embodiments, spikes 104 and 106 may each indicate a potential sand event to be interrogated by a sand detection system (e.g., sand detection system 50 shown in FIG. 1) in a given well system such as the well system 10 shown in FIG. 1.

At block 84, anomaly detection test 80 includes determining an ASD anomaly percentile datastream using the acoustic datastream received at block 82. In some embodiments, block 84 comprises determining an ASD standard deviation (SD) datastream (e.g., as a timeseries function) from the acoustic datastream (e.g., ASD acoustic datastream 102 shown in FIG. 3) received at block 82, followed by determining the ASD anomaly percentile datastream (e.g., as a timeseries function) from the determined ASD SD datastream. In certain embodiments, the ASD SD datastream determined from the acoustic datastream comprises a moving exponentially weighted SD that applies greater weight to recent observations (e.g., recent datapoints of ASD acoustic datastream 102) while decreasing exponentially the influence of older observations whereby the SD of the acoustic datastream may be determined while leveraging an exponential weighting scheme

To provide an example, FIG. 4 depicts a graph 110 depicting an exemplary ASD SD datastream 112 as a function of time. In this exemplary embodiment, ASD SD datastream 112 shown in FIG. 4 is determined from the ASD acoustic datastream 102 shown in FIG. 3. Particularly, ASD SD datastream 112 is determined from ASD acoustic datastream 102 and is exponentially weighted such that the weight assigned to each datapoint of ASD acoustic datastream 102 decays exponentially with time. ASD SD datastream 112 includes a pair of spikes 114 and 116 corresponding to the spikes 104 and 106 shown in the graph 100 of FIG. 3 but which are presented in terms of exponentially weighted SD of the ASD acoustic datastream 102 shown in FIG. 3.

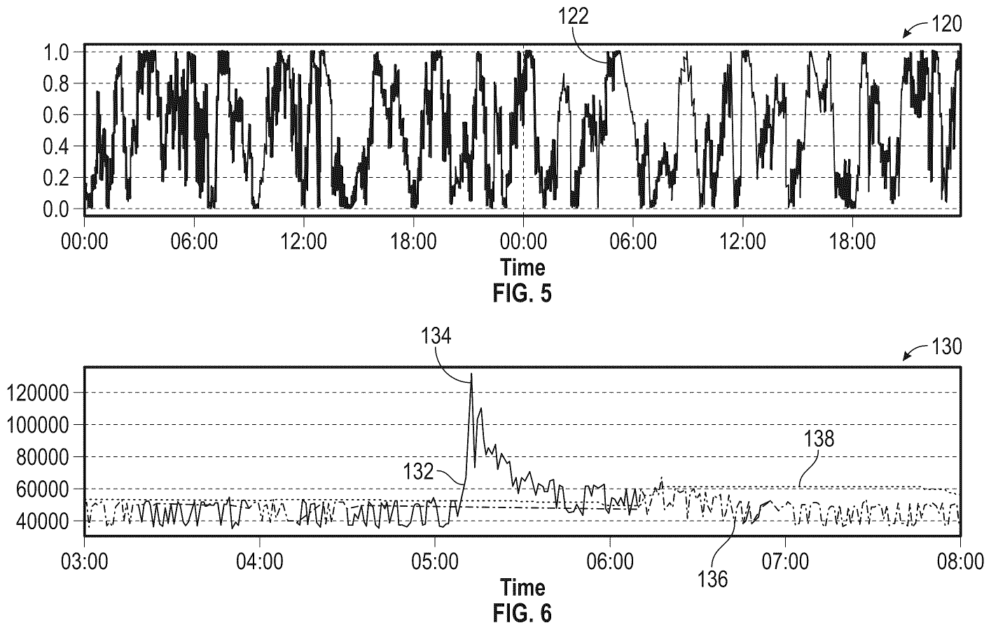

To provide an additional example, FIG. 5 includes an exemplary graph 120 depicting (as a timeseries function) an ASD anomaly percentile datastream 122 determined from or based on the ASD SD datastream 112 shown in FIG. 4. As shown in graph 120, ASD anomaly percentile datastream 122 ranges between 0.0 and 1.0 percentiles (e.g., 0th percentile to 100th percentile) and correlates with the magnitude of anomalies present in the ASD acoustic datastream 102 shown in FIG. 3 at different points in time. Particularly, in some embodiments, a rolling rank is used to determine the ASD anomaly percentile datastream as a percentile of the previously determined ASD SD datastream.

At block 86, anomaly detection test 80 includes determining an ASD anomaly multiplier datastream using the ASD anomaly percentile datastream determined at block 84. Generally, the ASD anomaly multiplier datastream is a timeseries function defining a ratio falling between zero and infinity representative of a multiplier of an ASD baseline datastream that is determined from the ASD anomaly percentile datastream determined at block 84. For instance, an ASD anomaly multiplier at a given point in time equal to 2.0 represents an ASD anomaly that is two times (2×) greater than the ASD baseline datastream.

In certain embodiments, the ASD anomaly multiplier datastream corresponds to the acoustic datastream received at block 82 divided by the temporally correlated ASD baseline datastream. In some embodiments, a despiked ASD datastream is first determined from the ASD anomaly percentile datastream determined at block 84. For instance, the acoustic datastream received at block 82 may be filtered whereby datapoints of the acoustic datastream greater than a selected percentile determined from the ASD anomaly percentile datastream (e.g., greater than the 0.50 or 50th percentile indicated in the ASD anomaly percentile datastream) are replaced with numerically undefined or not a number (NaN) values with the gaps formed in the resulting filtered datastream “filled in” to determine the despiked ASD datastream using interpolation such as, for example, linear interpolation, polynomial interpolation, spline interpolation, time-series interpolation, and the like. In some embodiments, the ASD baseline datastream is then determined from the computed despiked ASD datastream. For example, the ASD baseline datastream may comprise a rolling, selected quantile (e.g., corresponding to the 0.99 percentile, the 0.95 percentile, and the like) of the despiked ASD datastream whereby the ASD baseline datastream comprises an upper quantile baseline datastream.

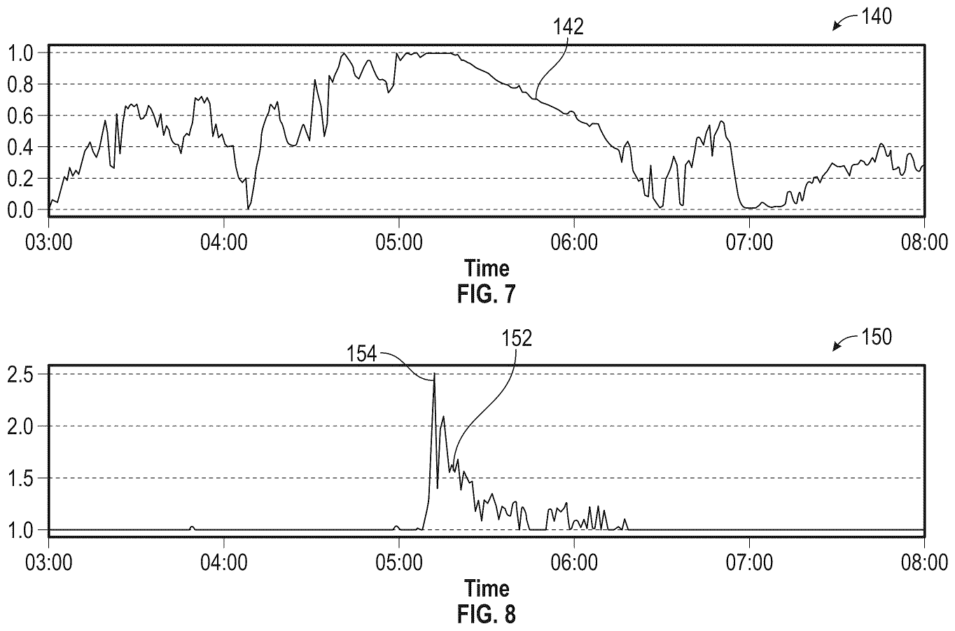

To provide an example, FIG. 6 includes a graph 130 depicting another ASD acoustic datastream 132 as an example of the acoustic datastream received at block 82, along with an exemplary despiked ASD datastream 136 obtained from the ASD acoustic datastream 132 (e.g., using an ASD anomaly percentile of the ASD acoustic datastream 132), and an exemplary ASD baseline datastream 138. Additionally, FIG. 7 includes a graph 140 depicting an exemplary ASD anomaly percentile datastream 142 determined from the ASD acoustic datastream 132 shown in FIG. 6. In this exemplary embodiment, ASD acoustic datastream 132 of FIG. 6 includes a spike 134 that is missing from both the despiked ASD datastream 136 and the ASD baseline datastream 138. Additionally, in this exemplary embodiment, a 0.50 percentile threshold is used to determine the despiked ASD datastream 136 such that despiked ASD datastream 136 is formed from only datapoints of the ASD acoustic datastream 132 that fall below the 0.50 percentile of the ASD anomaly percentile datastream 142 of FIG. 7 also determined from the ASD acoustic datastream 132. Further, in this exemplary embodiment, the ASD baseline datastream 138 corresponds to an upper quantile baseline datastream equal to the 0.99 percentile of the despiked ASD datastream 136.

FIG. 8 includes a graph 150 depicting an exemplary ASD anomaly multiplier datastream 152 as a timeseries function and which is determined by taking the ratio between the ASD acoustic datastream 132 and the ASD baseline datastream 138 shown in FIG. 5. ASD anomaly multiplier datastream 152 thus uses the ASD acoustic datastream 132 as a multiplier of the ASD baseline datastream 138 and includes a spike 154 corresponding temporally to the spike 134 of the ASD acoustic datastream 132. It may be noted that much of the noise present in ASD acoustic datastream 132 surrounding the spike 134 has been removed or filtered form the ASD anomaly multiplier datastream 152.

In some embodiments, the ASD anomaly multiplier determined at block 86 (with ASD anomaly multiplier datastream 152 provided as an example of such) comprises a sand test score determinable by the sand module 52 of the sand detection system 50 shown in FIG. 1. As indicated in graph 150, in at least some embodiments, the sand test score (in the form of ASD anomaly multiplier datastream 152 in this example) determined by sand module 52 may vary over time as a timeseries function. In certain embodiments, the ASD anomaly multiplier datastream determined at block 86 may be related with other sand test scores to provide a final or overall sand test score determinable by the sand module 52, as will be discussed further herein.

Referring to FIG. 8, an embodiment of a computer-implemented anomaly detection system 160 is shown. Anomaly detection system 160 is generally configured for administering anomaly detection tests including, for example, the anomaly detection test 80 shown in FIG. 2. In some embodiments, the anomaly detection system 160 may comprise a component of the sand detection system 50 shown in FIG. 1 such as, for example, by the sand module 52 of sand detection system 50.

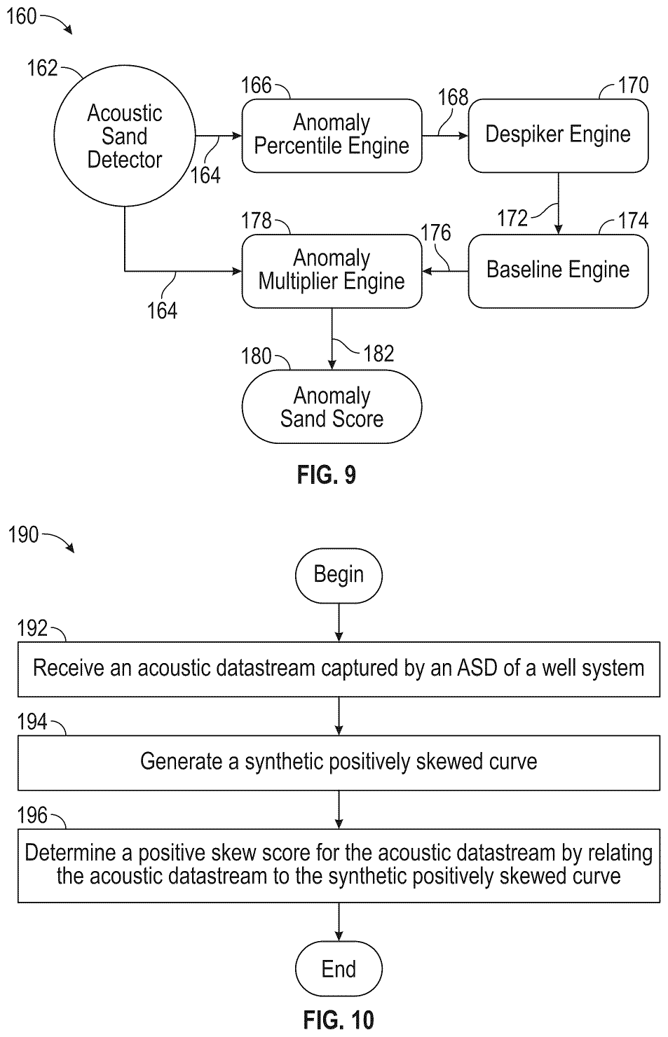

In this exemplary embodiment, anomaly detection system 160 generally includes one or more ASDs 162, an anomaly percentile engine 166, a despiker engine 170, a baseline engine 174, and an anomaly multiplier engine 178. ASDs 162 produce an ASD acoustic datastream (represented by arrows 164 in FIG. 9) that is received by both the anomaly percentile engine 166 and the anomaly multiplier engine 178. Anomaly percentile engine 166 of anomaly detection system 160 is generally configured to determine an ASD anomaly percentile datastream (represented by arrow 168 in FIG. 9) from the ASD acoustic datastream 164. In some embodiments, anomaly percentile engine 166 is configured to implement block 84 of the anomaly detection test 80 shown in FIG. 2 and the ASD anomaly percentile datastream 142 of FIG. 7 provides an example of the ASD anomaly percentile datastream 168. However, in other embodiments, the operation of anomaly percentile engine 166 may vary from block 84 of anomaly detection test 80.

The despiker engine 170 of anomaly detection system 160 is generally configured to determine a despiked ASD datastream (represented by arrow 172 in FIG. 9) from the ASD anomaly percentile datastream 168 provided by anomaly percentile engine 166. In certain embodiments, despiker engine 170 is configured to at least partially implement block 86 of anomaly detection test 80 of FIG. 2 with despiked ASD datastream 136 shown in FIG. 6 serving as an example of ASD despiked datastream 172. However, in other embodiments, the operation of despiker engine 170 may vary from block 86 of anomaly detection test 80.

The baseline engine 174 of anomaly detection system 160 is generally configured to determine an ASD baseline datastream (represented by arrow 176 in FIG. 9) from the ASD despiked datastream 172 provided by despiker engine 170. In certain embodiments, baseline engine 174 is configured to at least partially implement block 86 of anomaly detection test 80 of FIG. 2 with ASD baseline datastream 138 shown in FIG. 6 serving as an example of ASD baseline datastream 176. However, in other embodiments, the operation of baseline engine 174 may vary from block 86 of anomaly detection test 80.

The anomaly multiplier engine 178 of anomaly detection system 160 is generally configured to determine an anomaly sand score 180 in the form of an ASD anomaly multiplier datastream (represented by arrow 182 in FIG. 9) using both the ASD acoustic datastream 164 provided by ASDs 162 and the ASD baseline datastream 176 provided by baseline engine 174. In certain embodiments, anomaly multiplier engine 178 is configured to at least partially implement block 86 of anomaly detection test 80 of FIG. 2 with ASD anomaly multiplier datastream 152 shown in FIG. 8 serving as an example of ASD anomaly multiplier datastream 182. However, in other embodiments, the operation of anomaly multiplier engine 178 may vary from block 86 of anomaly detection test 80.

As described above, in some embodiments, the one or more sand tests administered by sand module 52 comprises a positive skew detection test which is generally configured to detect periods or patterns of acoustic signals (captured in the one or more acoustic datastreams) exhibiting a positive skew that indicate, or are associated with, a sand event in well system 10. As used herein, the term “positive skew” and “positively skewed” refer to functions such as timeseries functions that exhibit a sharp increase in magnitude directly followed by a gradual decay.

For example, and referring to FIGS. 10-13, FIG. 10 depicts an embodiment of a method 190 for administering a positive skew detection test, and which may also be referred to herein as positive skew detection test 190. In some embodiments, the positive skew detection test 190 may be administered by the sand detection system 50 shown in FIG. 1 including, for example, by the sand module 52 of sand detection system 50.

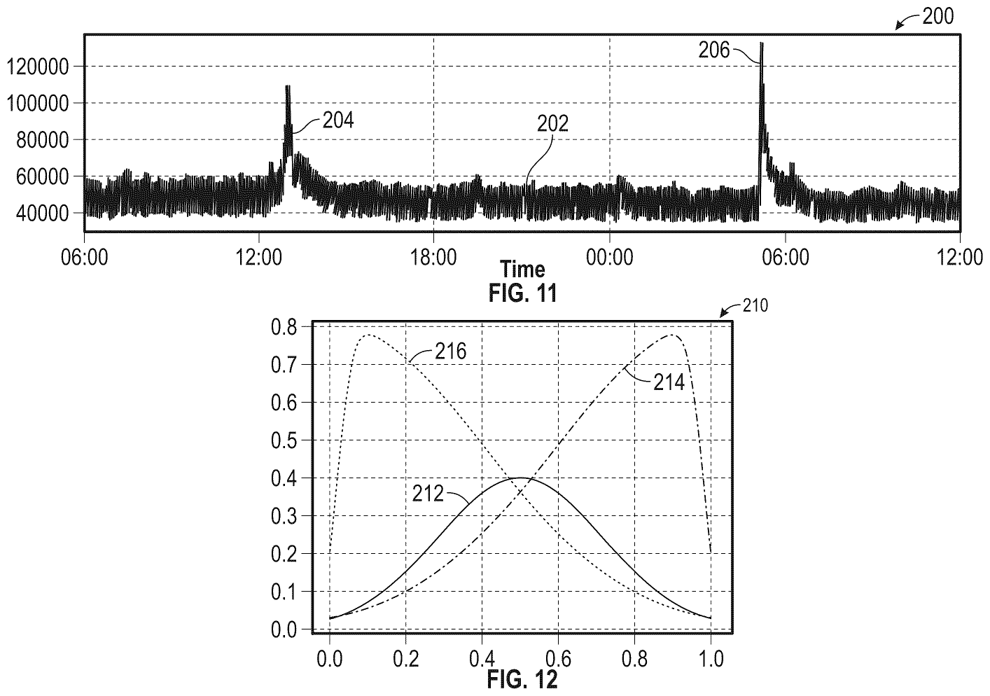

Beginning at block 192, positive skew detection test 190 includes receiving an acoustic datastream captured by an ASD (e.g., ASD 40 shown in FIG. 1) of a well system (e.g., well system 10 shown in FIG. 1). For instance, FIG. 11 depicts a graph 200 depicting an exemplary ASD acoustic datastream 202 captured by an ASD such as the ASD 40 of well system 10 shown in FIG. 1. In certain embodiments, block 192 includes receiving an acoustic datastream similar to the ASD acoustic datastream 202 shown in graph 200 In this example, the ASD acoustic datastream 202 includes a pair of spikes 204 and 206 occurring at different points in time. In some embodiments, spikes 204 and 206 may each indicate a potential sand event to be interrogated by a sand detection system (e.g., sand detection system 50 shown in FIG. 1) in a given well system such as the well system 10 shown in FIG. 1.

At block 194, method 190 includes generating a synthetic positively skewed curve. The synthetic positively skewed curve may have a positive skew score substantially equal to 1.0 and thus may represent an idealized positively skewed curve which may serve as a baseline for comparison with the acoustic datastream received at block 192. For example, FIG. 12 depicts a graph 210 including a synthetic neutral skew curve 212 having a positive skew score substantially equal to 0.0, a synthetic negatively skewed curve having a positive skew score substantially equal to −1.0, and finally, a synthetic positively skewed curve 216 having a positive skew score substantially equal to 1.0.

At block 196, method 190 includes determining a positive skew score for the acoustic datastream received at block 192 by relating the acoustic datastream to the synthetic positively skewed curve generated at block 194. For instance, in an embodiment, the ASD acoustic datastream 202 shown in graph 200 (including spikes 204 and 206) may be related to the synthetic positively skewed curve 216 shown in graph 210 to determine a positive skew score for the ASD acoustic datastream 202 that falls between −1.0 (negatively skewed) and 1.0 (positively skewed).

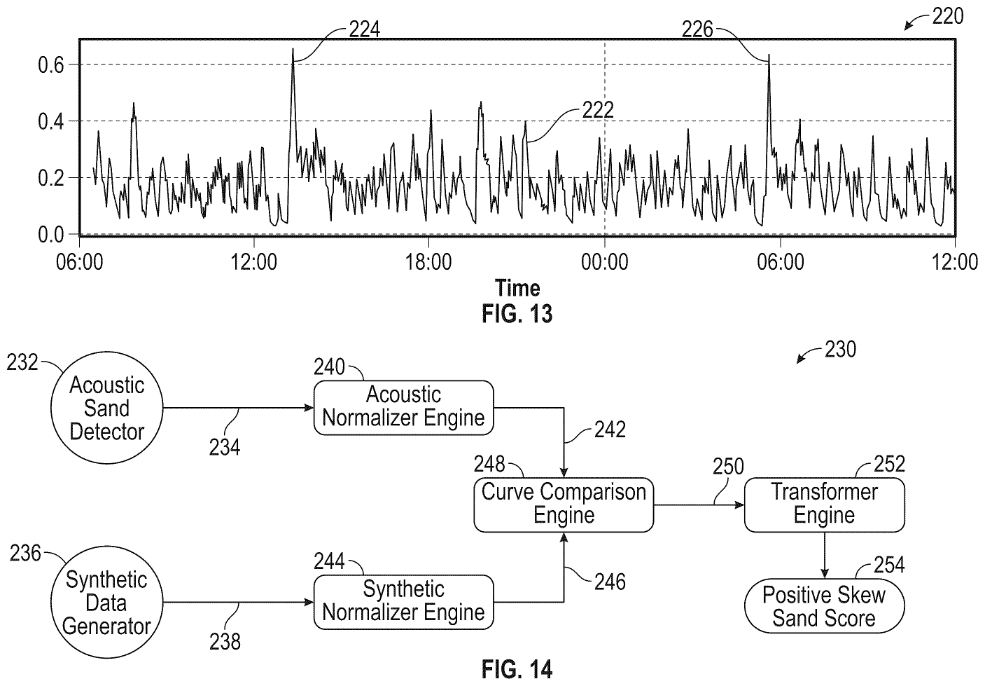

In some embodiments, block 196 comprises normalizing both the acoustic datastream received at block 192 and the synthetic positively skewed curve generated at block 214 between 0.0 and 1.0. In certain embodiments, dynamic time warping is employed to determine a distance metric between the normalized acoustic datastream and the normalized synthetic positively skewed curve in order to determine the positive skew score of the acoustic datastream at different points in time. To provide an example, FIG. 13 depicts a graph 220 plotting an exemplary positive skew score 222 of the ASD acoustic datastream 202 shown in graph 200 as a timeseries function that varies over time. For instance, the spikes 204 and 206 of ASD acoustic datastream 202 may be correlated to a corresponding pair of spikes 224 and 226 in the positive skew score 222 shown in graph 220.

In some embodiments, the positive skew score determined at block 196 comprises a sand test score determinable by the sand module 52 of the sand detection system 50 shown in FIG. 1. In certain embodiments, the positive skew score determined at block 196 may be related with other sand test scores to provide a final or overall sand test score determinable by the sand module 52. For instance, in certain embodiments, the positive skew score determined at block 196 may be related with the ASD anomaly multiplier determined at block 86 of the anomaly detection test 80 shown in FIG. 2. For instance, these two sand test scores may be averaged together (not necessarily weighted equally) to provide the overall sand test score for the sand module 52 for a given point in time for an ASD acoustic datastream. In other embodiments, the positive skew score and the ASD anomaly multiplier may be related in ways other than through averaging. In still other embodiments, the positive skew score and the ASD anomaly multiplier may be related with additional sand test scores in order to provide the overall sand test score for sand module 52.

Referring to FIG. 14, an embodiment of a computer-implemented positive skew detection system 230 is shown. Positive skew detection system 230 is generally configured for administering positive skew detection tests including, for example, the positive skew detection test 190 shown in FIG. 9. In some embodiments, the positive skew detection system 230 may comprise a component of the sand detection system 50 shown in FIG. 1 such as, for example, by the sand module 52 of sand detection system 50. In this exemplary embodiment, positive skew detection system 230 generally includes one or more ASDs 232, a synthetic data generator 236, an acoustic normalizer engine 240, a synthetic normalizer engine 244, a curve comparison engine 248, and a transformer engine 252.

The synthetic data generator 236 of positive skew detection system 230 is generally configured to produce or generate a synthetic positively skewed function or curve (represented by arrow 238 in FIG. 14). In some embodiments, synthetic data generator 236 is configured to at least partially implement block 194 of the positive skew detection test 190 shown in FIG. 10 and the synthetic positively skewed curve 238 has a positive skew score substantially equal to 1.0 representing the idealized positively skewed curve.

The acoustic normalizer engine 240 of positive skew detection system 230 is configured to normalize the ASD acoustic datastream 234 provided by ASDs 232 to determine a normalized acoustic datastream (indicated by arrow 242 in FIG. 14). Similarly, the synthetic normalizer engine 244 of positive skew detection system 230 is configured to normalize the synthetic positively skewed curve 238 to produce a normalized positively skewed curve (represented by arrow 246 in FIG. 14). In some embodiments, normalizer engines 240 and/or 244 are configured to at least partially implement block 196 of the positive skew detection test 190 shown in FIG. 10. For instance, normalizer engines 240 and 244 may normalize or scale the ASD acoustic datastream 234 and the synthetic positively skewed curve 238, respectively, to fit the same predefined (e.g., user-selected) scale such as between 0.0 and 1.0.

The curve comparison engine 248 of positive skew detection system 230 receives both the normalized acoustic datastream 242 from acoustic normalizer engine 240 and the normalized positively skewed curve 246 from the synthetic normalizer engine 244, and determines therefrom a distance metric (represented by arrow 250 in FIG. 14) between the normalized acoustic datastream 242 and the normalized positively skewed curve 246. In some embodiments, curve comparison engine 248 is configured to at least partially implement block 196 of positive skew detection test 190 shown in FIG. 10. In certain embodiments, curve comparison engine 248 employs time warping such as DTW to find an optimal alignment between the normalized acoustic datastream 242 and the normalized positively skewed curve 246 to minimize a cumulative distance therebetween where the distance metric 250 corresponds to a DTW distance or cost (e.g., a Euclidean distance) representing the dissimilarity of the normalized acoustic datastream 242 and the normalized positively skewed curve 246 with a lower DTW distance increasing a higher degree of similarity.

The transformer engine 252 of positive skew detection system 230 receives the distance metric 250 determined by curve comparison engine 248 and transforms the distance metric 250 into a positive skew and score 254 as an output of positive skew detection system 230. In some embodiments, transformer engine 252 applies an exponential transformation to the distance metric 250 with distance metric 250 serving as the exponential independent variable of the exponential transformation and the positive skew sand score 256 serving as the dependent variable or output of the exponential transformation. In other embodiments, positive skew detection system 230 may not include the transformer engine 252 shown in FIG. 14.

As described above, in some embodiments, the noise module 54 of the sand detection system shown in FIG. 1 is configured to administer one more noise tests for determining one or more noise tests each negatively correlated with a probability of the one or more acoustic datastreams tested by noise module 54 capturing a sand event in the well system 10. Instead, the noise tests administrable by noise module 54 may detect or indicate the occurrence of one or more noise events in an acoustic datastream.

In some embodiments, the one or more noise tests administrable by the noise module 54 shown in FIG. 1 includes a baseline jump detection test configured to detect or identify baseline jumps in ASD acoustic datastreams where a baseline of the ASD acoustic datastream increases or decreases sharply in magnitude and subsequently remains at the elevated baseline. Baseline jumps in an ASD acoustic datastream may be indicative of a noise event rather than a sand event given that baseline jumps may be caused by non-sand related pressure changes such as well routing changes, gas breakthrough changes, and the like. In some embodiments, a baseline jump in an ASD acoustic datastream is defined by two separate (e.g., independent) parameters: sequential modality and post-jump stability. In other words, in at least some embodiments, a baseline jump in an ASD acoustic datastream is identified through exhibiting both sequential modality and post-jump stability.

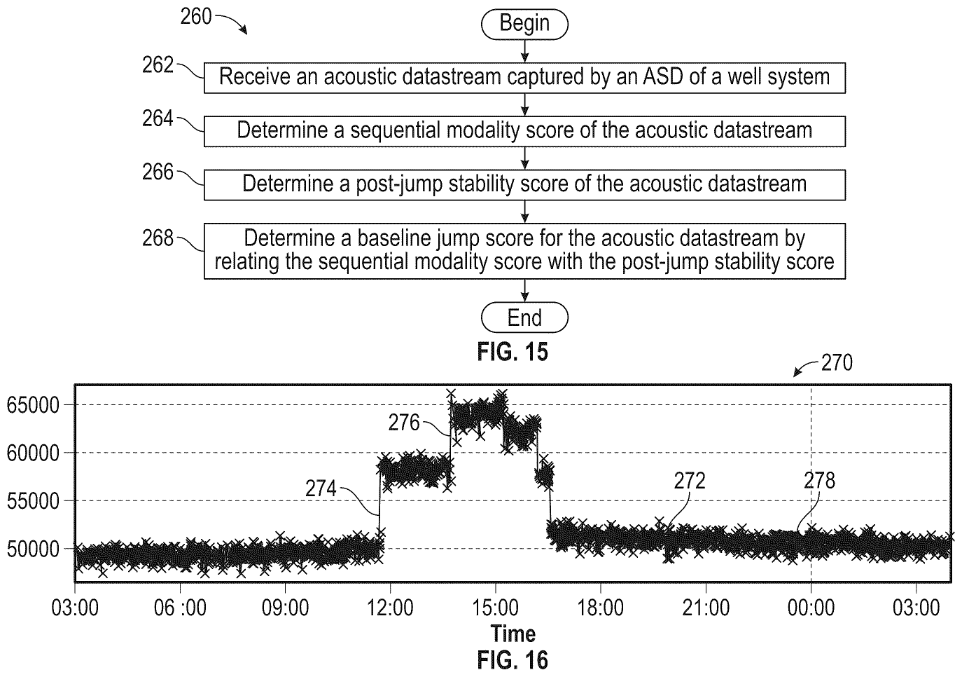

Referring to FIGS. 15-19, FIG. 15 depicts an embodiment of a method 260 for administering a baseline jump detection test, and which may also be referred to herein as baseline jump detection test 260. In some embodiments, the baseline jump detection test 260 may be administered by the sand detection system 50 shown in FIG. 1 including, for example, by the noise module 54 of sand detection system 50. Beginning at block 262, baseline jump detection test 260 includes receiving an acoustic datastream captured by an ASD (e.g., ASD 40 shown in FIG. 1) of a well system (e.g., well system 10 shown in FIG. 1). For instance, FIG. 16 depicts a graph 270 depicting an exemplary ASD acoustic datastream 272 captured by an ASD such as the ASD 40 of well system 10 shown in FIG. 1. In certain embodiments, block 262 includes receiving an acoustic datastream similar to the ASD acoustic datastream 272 shown in graph 270 In this example, the ASD acoustic datastream 272 includes a series of spikes 274, 276, and 278 occurring at different points in time. In some embodiments, spikes 274, 276, and 278 may each indicate a potential sand event to be interrogated by a sand detection system (e.g., sand detection system 50 shown in FIG. 1) in a given well system such as the well system 10 shown in FIG. 1.

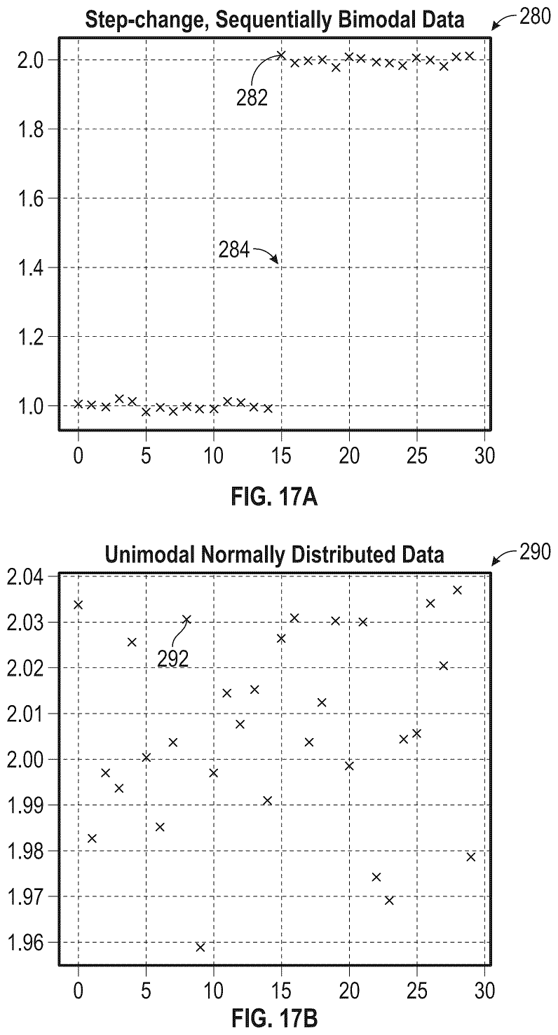

At block 264, baseline jump detection test 260 includes determining a sequential modality score of the acoustic datastream (e.g., ASD acoustic datastream 272) received at block 262. In some embodiments, the sequential modality score may be a timeseries function that varies over time in accordance with changes over time in the acoustic datastream. The sequential modality score may identify a step-change in the ASD datastream using different techniques. For example, in certain embodiments, block 264 includes applying Hartigan's Dip Test (HDT) on a rolling window (e.g., having a defined window size) of the acoustic datastream received at block 262. The HDT may return a value less than 0.05 indicating significant bimodality, a value greater than 0.05 but less than 0.10 suggesting bimodality with marginal significance. These values may be transformed into the bimodality test score. For instance, in certain embodiments, the sequential modality score, such as one determined by applying HDT, ranges between 0.0 (indicating unimodality) and 1.0 (indicating sequential bimodality). To provide an example, FIGS. 17A and 17B illustrate graphs 280 and 290 are shown, respectively, depicting a first set of datapoints 282 and a second set of datapoints 292 (only a single datapoint being labeled in each graph 280 and 290 in the interest of clarity), respectively. Each set of datapoints 282 and 292 correspond to different timeseries data with the X-axes of graphs 280 and 290 representing time in seconds. The first set of datapoints 282 exhibits sequential bimodality and has a sequential modality score using HDT of substantially equal to 1.0 with a jump or step-change 284 occurring at approximately 15 seconds. Conversely, the second set of datapoints 292 exhibits unimodality and has a sequential modality score using HDT of substantially equal to 0.0. Thus, no step-change is indicated in graph 290.

At block 266, baseline jump detection test 260 includes determining a post-jump stability score of the acoustic datastream (e.g., ASD acoustic datastream 272) received at block 262. In some embodiments, the post-jump stability score may be a timeseries function that varies over time in accordance with changes over time in the acoustic datastream. The post-jump stability score indicates the level of stability in the acoustic datastream directly following a step-change (e.g., step-change 284 shown in graph 280) whereby the acoustic datastream exhibits a low standard deviation with a horizontal trend directly following the step-change. In certain embodiments, block 264 includes applying a post-jump stability test on a rolling window (e.g., correlated with the rolling window used to determine the sequential modality score) of the acoustic datastream received at block 262. In certain embodiments, the post-jump stability score ranges between 0.0 (indicating post-jump instability) and 1.0 (indicating post-jump stability).

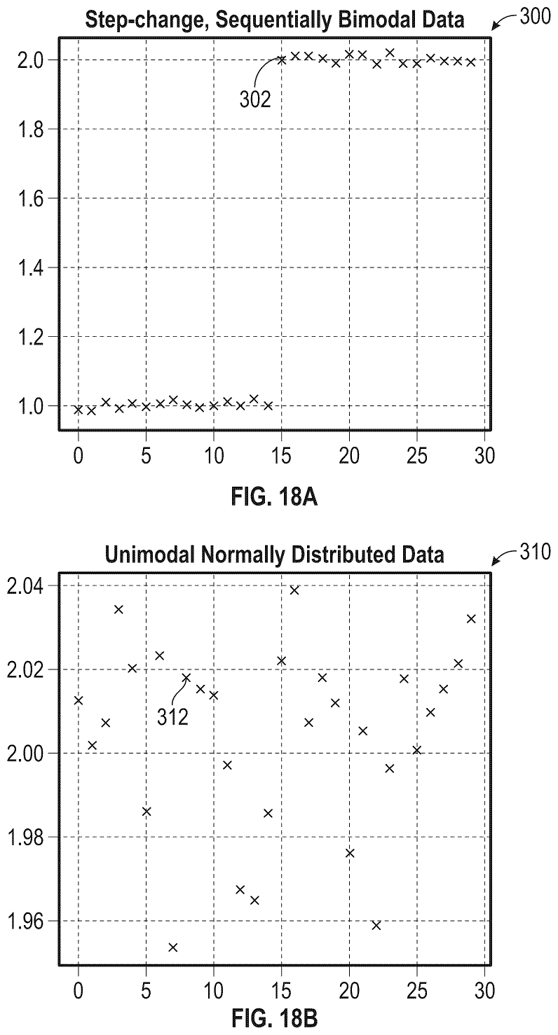

To provide an example, FIGS. 18A and 18B illustrate graphs 300 and 310 are shown, respectively, depicting a first set of datapoints 302 and a second set of datapoints 312 (only a single datapoint being labeled in each graph 300 and 310 in the interest of clarity), respectively. Each set of datapoints 302 and 312 correspond to different timeseries data with the X-axes of graphs 300 and 310 representing time in seconds. The first set of datapoints 302 exhibits stability and has a post-jump stability score substantially equal to 1.0; conversely, the second set of datapoints 312 exhibits unimodality and has a post-jump stability score of substantially equal to 0.0.

At block 268, baseline jump detection test 260 includes determining a baseline jump score of the acoustic datastream (e.g., ASD acoustic datastream 272) received at block 262 by relating the post-jump stability score determined at block 264 with the post-jump stability score (e.g., for the same point in time) of the acoustic datastream. Again, in some embodiments, the baseline jump score may be a timeseries function that varies over time in accordance with changes over time in the acoustic datastream. For instance, the sequential modality score and post-jump stability score for a given point in time (or a given rolling window of a defined size) may be related through averaging the two scores, adding the two scores together, or otherwise comparing, contrasting, or combining the pair of scores. In some embodiments, the baseline jump score has a user-defined time decay. For instance, the decay may be determined using a rolling, exponentially weighted sum of an initial or raw baseline jump score.

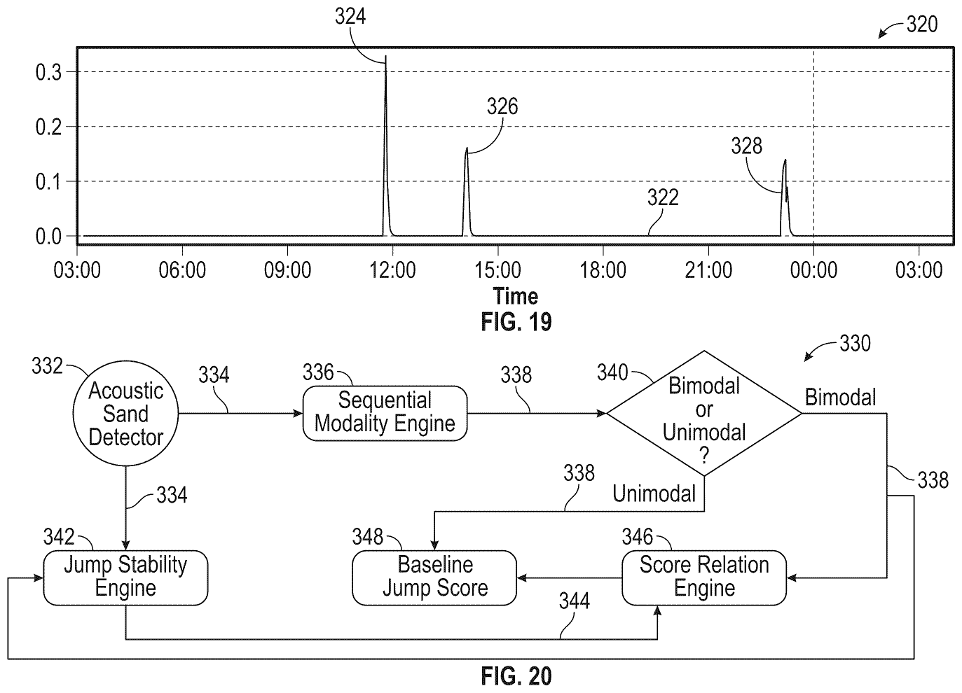

Additionally, FIG. 19 depicts a graph 320 depicting (as a timeseries function) a baseline jump score 322 for the ASD acoustic datastream 272 shown in graph 270. The baseline jump score 322 may range between 0.0 and 1.0 but achieves a maximum for the sample shown in graph 320 of approximately 0.33. Additionally, baseline jump score 322 includes separate spikes 324, 326, and 328 which correlate with the spikes 274, 276, and 278 of the ASD acoustic datastream 272. In some embodiments, the baseline jump score (e.g., baseline jump score 322) comprises a noise test score determinable by the noise module 54 of the sand detection system 50 shown in FIG. 1. In certain embodiments, the baseline jump score determined at block 268 may be related with other noise test scores to provide a final or overall noise test score determinable by the noise module 54.

Referring to FIG. 20, an embodiment of a computer-implemented baseline jump detection system 330 is shown. Baseline jump detection system 330 is generally configured for administering baseline jump detection tests including, for example, the baseline jump detection test 260 shown in FIG. 15. In some embodiments, the baseline jump detection system 330 may comprise a component of the sand detection system 50 shown in FIG. 1 such as, for example, by the noise module 54 of sand detection system 50. In this exemplary embodiment, baseline jump detection system 330 generally includes one or more ASDs 332 configured to capture an ASD acoustic datastream (represented by arrow 334 in FIG. 20), a sequential modality engine 336, a modality identifier 340, and a jump stability engine 342, and a score relation engine 346.

The sequential modality engine 336 of baseline jump detection system 330 determines a sequential modality score (represented by arrow 338 in FIG. 20) from the ASD acoustic datastream 334 received from the ASDs 332. In some embodiments, sequential modality engine 336 is configured to at least partially implement block 264 of the baseline jump detection test 260 shown in FIG. 15. In certain embodiments, sequential modality engine 336 applies a modality test to the ASD acoustic datastream 334 such as, for example, HDT, in order to determine the sequential modality score 338. The result of the modality test may be transformed to a scale extending between 0.0 and 1.0, for example, with 0.0 indicating unimodality and 1.0 indicating bimodality.

The modality identifier 340 of baseline jump detection system 330 receives the sequential modality score 338 and determines therefrom whether the sequential modality score 338 indicates either unimodality or bimodality in the ASD acoustic datastream 334. If the modality identifier 340 identifies by the sequential modality score 338 unimodality in the ASD acoustic datastream 334, then the baseline jump detection system 330 is configured to output the sequential modality score 338 as a baseline jump score 348. Conversely, if the modality identifier 340 identifies by the sequential modality score 338 bimodality in the ASD acoustic datastream 334, then the sequential modality score 338 is provided to the score relation engine 346 before the baseline jump detection system 330 determines the baseline jump score 348.

The jump stability engine 342 of baseline jump detection system 330 determines a post-jump stability score 344 based on the ASD acoustic datastream 334. In some embodiments, jump stability engine 342 at least partially implements block 266 of the baseline jump detection test 260. In certain embodiments, the post-jump stability score 344 corresponds to the level of stability in the ASD acoustic datastream 334 directly following a step-change whereby the ASD acoustic datastream 334 exhibits a low standard deviation with a horizontal trend directly following the step-change. In some embodiments, the step-change (e.g., the location in time of which) may be identified by jump stability engine 342 using the sequential modality score 338.

The score relation engine 346 of baseline jump detection system 330 relates the sequential modality score 338 with the post-jump stability score 344 to determine the baseline jump score 348 in instances when the modality identifier 340 identifies by the sequential modality score 338 bimodality in the ASD acoustic datastream 334. In certain embodiments, score relation engine 346 is configured to at least partially implement block 268 of the baseline jump detection test 260. For instance, according to a predefined (e.g., user-defined) rule of score relation engine 346, the score relation engine 346 may combine or compare the sequential modality score 338 and the post-jump stability score 344 when determining the baseline jump score 348.

In some embodiments, the one or more noise tests administrable by the noise module 54 shown in FIG. 1 includes a data fitness test configured to detect or identify periods or episodes of poor data fitness or quality of an ASD acoustic datastream. Such episodes of poor data fitness that could affect the efficacy of sand detection system 50 shown in FIG. 1 if not excluded or otherwise corrected against. Issues which can affect data fitness of the ASD acoustic datastream include, among others, missing datapoints of the acoustic datastream, and/or sensor dropout whereby the ASD returns zero values for one or more datapoints of the acoustic datastream.

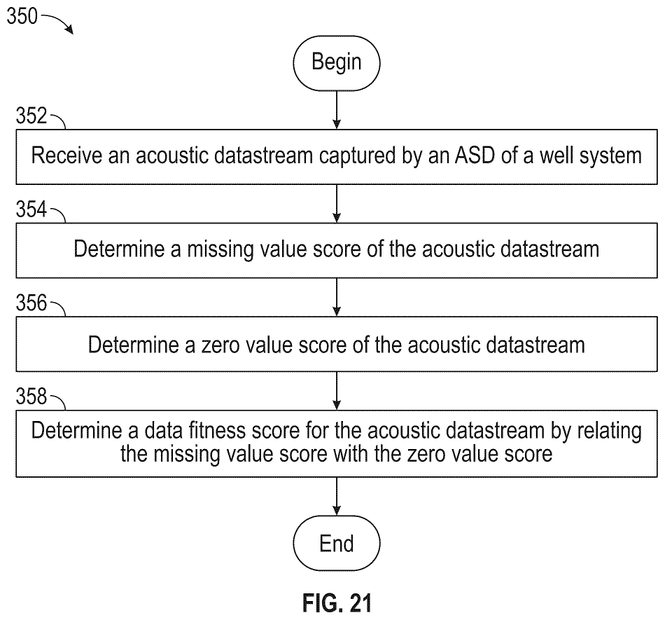

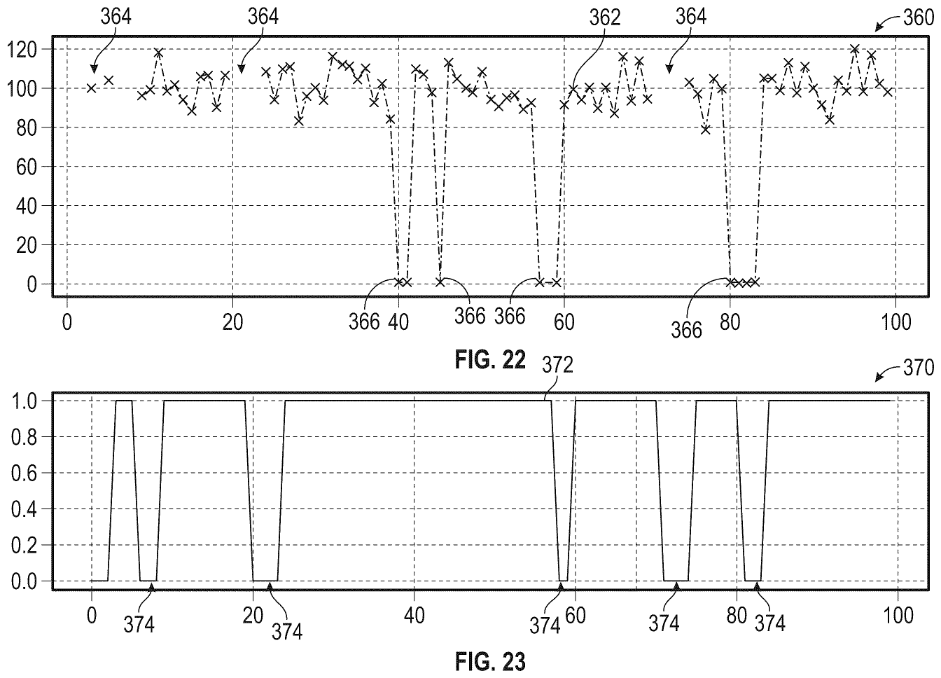

Referring to FIGS. 21-26, FIG. 21 depicts an embodiment of a method 350 for administering a data fitness test, and which may also be referred to herein as data fitness test 350. In some embodiments, the data fitness test 350 may be administered by the sand detection system 50 shown in FIG. 1 including, for example, by the noise module 54 of sand detection system 50. Beginning at block 352, data fitness test 350 includes receiving an acoustic datastream captured by an ASD (e.g., ASD 40 shown in FIG. 1) of a well system (e.g., well system 10 shown in FIG. 1). For instance, FIG. 22 depicts a graph 360 depicting an exemplary ASD acoustic datastream 362 captured by an ASD such as the ASD 40 of well system 10 shown in FIG. 1. In certain embodiments, block 352 includes receiving an acoustic datastream similar to the ASD acoustic datastream 362 shown in graph 360 In this example, the ASD acoustic datastream 362 includes several missing values 364 and several zero values 366. In this context, missing value refers to a missing or absent datapoint of a datastream in view of a sampling rate of the sensor generating the datastream. Additionally, zero values refer to datapoints captured by a sensor that are equal to 0.0. Both missing values and zero values are likely to be spurious such as the result of a damaged or inoperable sensor.

At block 354, data fitness test 350 includes determining a missing value score of the acoustic datastream (e.g., ASD acoustic datastream 362) received at block 352. In some embodiments, the missing value score may be a timeseries function that varies over time in accordance with changes over time in the acoustic datastream. The missing value score may identify episodes of missing values or datapoints in the acoustic datastream in view of a sampling rate of the ASD from which the acoustic datastream is captured. In some embodiments, the missing value score ranges between 0.0 and 1.0, where the score of 0.0 is returned for a given period in time when a predefined number of consecutive values or datapoints of the acoustic datastream are identified as missing but otherwise returns a score of 1.0. As an example, FIG. 23 depicts a graph 370 that plots an exemplary missing value score 372 over time and which is based on the ASD acoustic datastream 362 shown in graph 360. In this example, missing value score 372 includes several separate 0.0 scores (indicated by arrows 374 in graph 370) that correlate with the missing values 364 of ASD acoustic datastream 362.

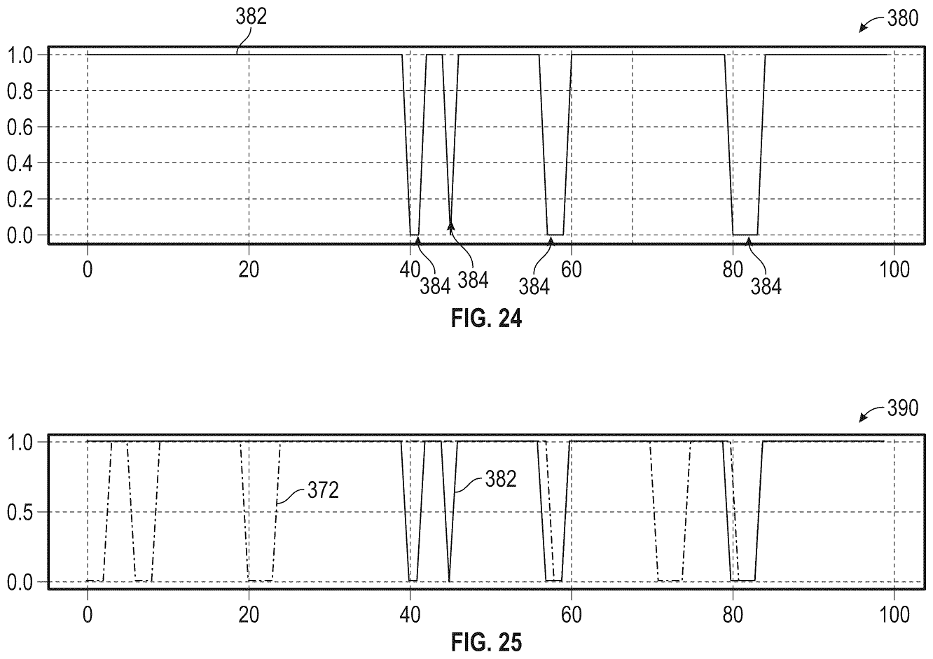

At block 356, data fitness test 350 includes determining a zero value score of the acoustic datastream (e.g., ASD acoustic datastream 362) received at block 352. In some embodiments, the zero value score may be a timeseries function that varies over time in accordance with changes over time in the acoustic datastream. The zero value score may identify episodes of where the given ASD returns a value of zero (e.g., 0.0) in the ASD acoustic datastream. In some embodiments, the zero value score ranges between 0.0 and 1.0, where, similar to the missing value score described above, the score of 0.0 is returned for a given period in time when a predefined number (e.g., a user-defined number) of consecutive values or datapoints of the acoustic datastream are identified as zero but otherwise returns a score of 1.0. As an example, FIG. 24 depicts a graph 380 that plots an exemplary zero value score 382 over time and which is based on the ASD acoustic datastream 362 shown in graph 360. In this example, zero value score 382 includes several separate 0.0 scores (indicated by arrows 384) that correlate with the zero values 366 of ASD acoustic datastream 362.

At block 358, data fitness test 350 includes determining a data fitness score of the acoustic datastream (e.g., ASD acoustic datastream 362) received at block 352 by relating the missing value score determined at block 354 with the zero value score determined at block 356. Again, in some embodiments, the data fitness score may be a timeseries function that varies over time in accordance with changes over time in the acoustic datastream. In certain embodiments, the missing value score and zero value score for a given point in time (or a given rolling window of a defined size) may be related through averaging the two scores, adding the two scores together, or otherwise comparing, contrasting, or combining the pair of scores. Additionally, in some embodiments, the data fitness score has a user-defined time decay which may, in some embodiments, comprise an exponentially weighted sum.

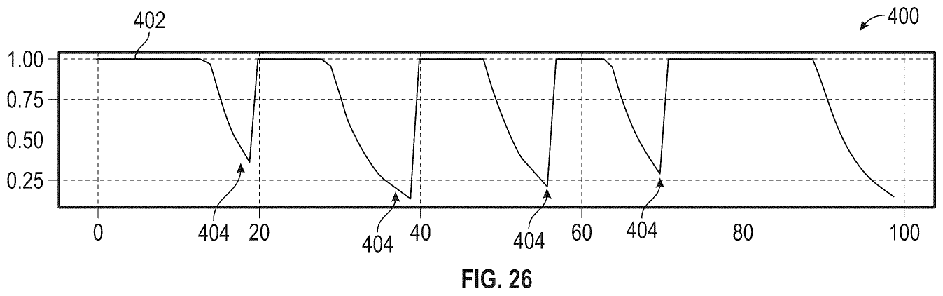

Additionally, FIG. 25 depicts a graph 390 depicting (as a timeseries function) the missing value score 372 of graph 370 overlaid with the zero value score 382 shown in graph 380. Graph 390 depicts that at a given point in time an acoustic datastream (e.g., ASD acoustic datastream 362 of graph 360) may return a missing value score 372 equal to 0.0 and a zero value score 382 equal to 1.0 and vice-a-versa. Further, FIG. 26 depicts a graph 400 depicting (as a timeseries function) an exemplary data fitness score 402 which relates the missing value score 372 and zero value score 382 shown in graph 390. By providing an overall data fitness metric capturing both missing and zero values, the data fitness score 402 may be used to identify specific spikes (indicated by arrows 404 in graph 400) of poor data quality or fitness that may be accounted for in detecting or identifying one or more corresponding noise events in the acoustic datastream (e.g., ASD acoustic datastream 362) from which the data fitness score 402 is determined.

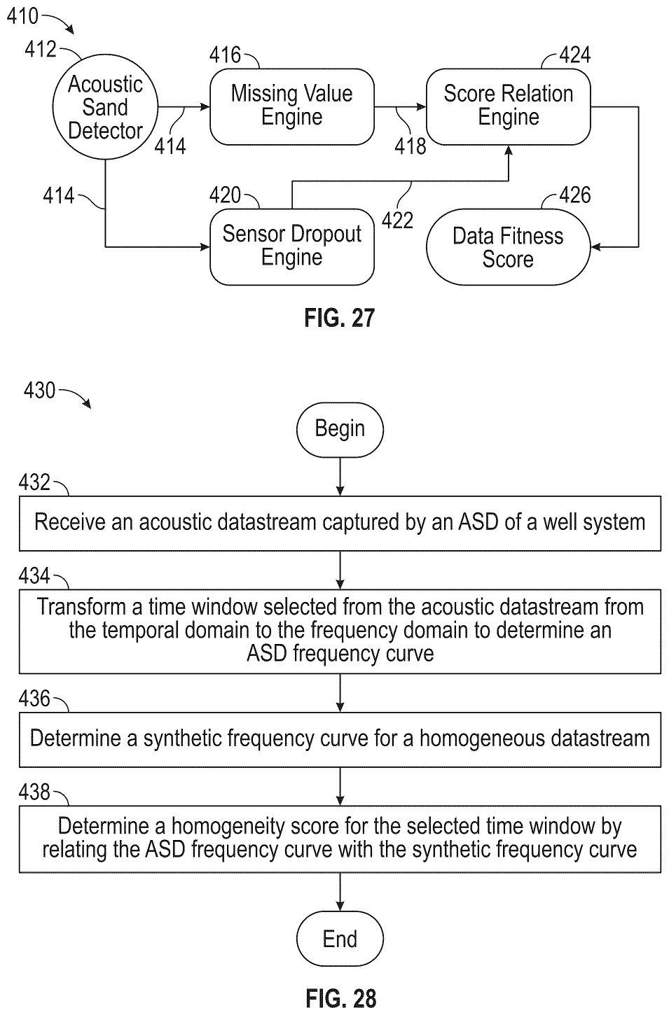

Referring to FIG. 27, an embodiment of a data fitness testing system 410 is shown. Data fitness testing system 410 is generally configured for administering baseline jump detection tests including, for example, the baseline jump detection test 260 shown in FIG. 15. In some embodiments, the data fitness testing system 410 may comprise a component of the sand detection system 50 shown in FIG. 1 such as, for example, by the noise module 54 of sand detection system 50. In this exemplary embodiment, data fitness testing system 410 generally includes one or more ASDs 412 configured to capture an ASD acoustic datastream (represented by arrows 414 in FIG. 20), a missing value engine 416, a sensor dropout engine 420, and a score relation engine 424 configured to determine a data fitness score 426 as an output of the data fitness testing system 410.

The missing value engine 416 of data fitness testing system 410 determines a missing value score (represented by arrow 418 in FIG. 27) using the ASD acoustic datastream 414 provided by the ASDs 412. The missing value score 418 is provided by the missing value engine 416 to the score relation engine 424. In some embodiments, missing value engine 416 is configured to at least partially implement block 354 of the data fitness test 350 shown in FIG. 21. For instance, the missing value score 418 may identify episodes of missing values or datapoints in the acoustic datastream in view of a sampling rate of the ASDs 412 from which the ASD acoustic datastream 414 is captured. In certain embodiments, the missing value score 418 may be correlated with the presence of consecutive missing values or datapoints in the ASD acoustic datastream 414.

The sensor dropout engine 420 of data fitness testing system 410 determines a zero value score (represented by arrow 422 in FIG. 27) using the ASD acoustic datastream 414 provided by the ASDs 412. The zero value score 422 is provided by the sensor dropout engine 420 to the score relation engine 424. In some embodiments, sensor dropout engine 420 is configured to at least partially implement block 356 of the data fitness test 350 shown in FIG. 21. For instance, the zero value score 422 may correlate to periods of time in which the ASD acoustic datastream 414 reports consecutive values or datapoints equal to zero—indicative of sensor dropout or other issues with respect to the ASDs 412.

In this exemplary embodiment, the score relation engine 424 of data fitness testing system 410 relates the missing value score 418 with the zero value score 422 to determine the data fitness score 426. In other embodiments, missing value score 418, zero value score 422, and/or other scores independently or in combination may be taken as the data fitness score 426. In certain embodiments, score relation engine 424 is configured to at least partially implement block 358 of data fitness test 350 shown in FIG. 21. For instance, according to a predefined (e.g., user-defined) rule of score relation engine 424, the score relation engine 424 may combine or compare the missing value score 418 and the zero value score 422 when determining the data fitness score 426.

In some embodiments, the one or more noise tests administrable by the noise module 54 shown in FIG. 1 includes a homogeneity detection test configured to detect or identify periods of homogeneity in an acoustic datastream. Particularly, sand events are generally anomalous and thus periods of homogeneity in an ASD acoustic datastream indicate the occurrence of a noise event rather than a sand event in the ASD acoustic datastream such as other physical processes unrelated to sanding such as slugging and/or loose vibrating sensors and the like.

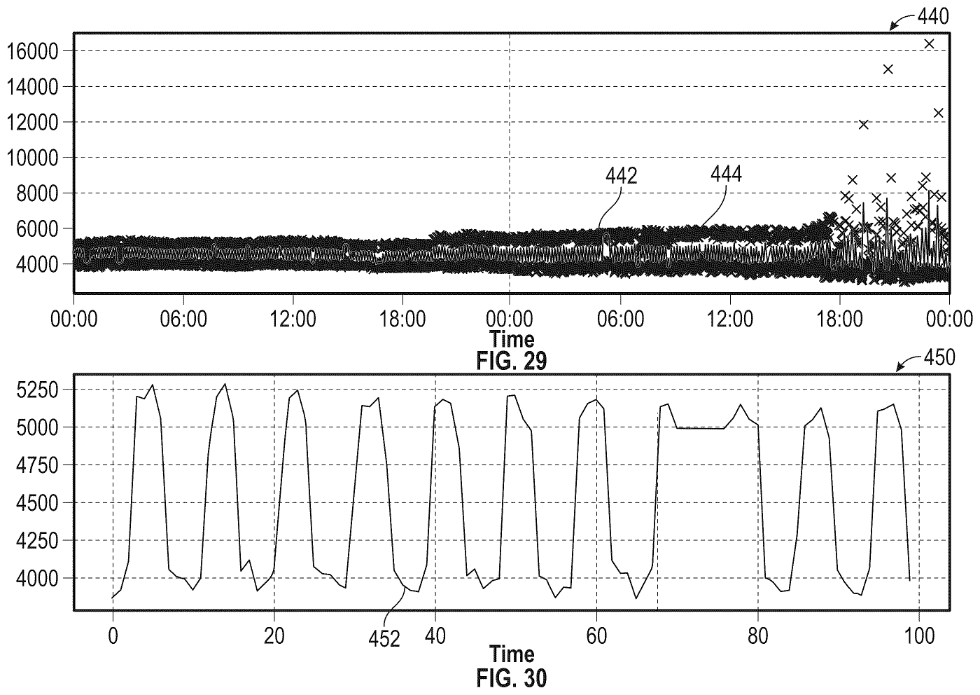

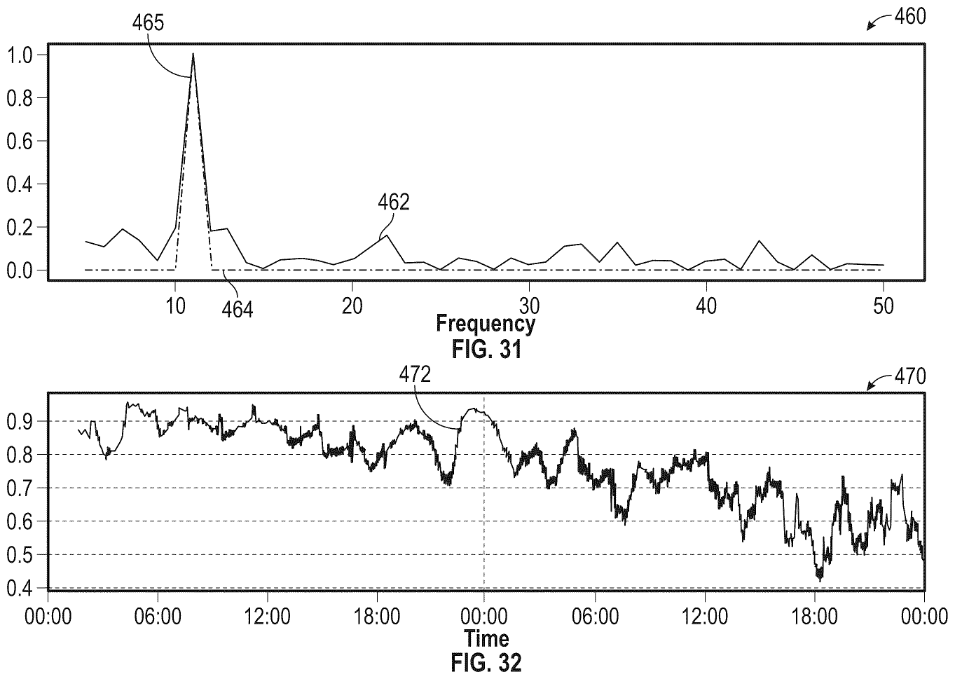

Referring to FIGS. 28-32, FIG. 28 depicts an embodiment of a method 430 for administering a homogeneity detection test, and which may also be referred to herein as homogeneity detection test 430. In some embodiments, the homogeneity detection test 430 may be administered by the sand detection system 50 shown in FIG. 1 including, for example, by the noise module 54 of sand detection system 50. Beginning at block 432, homogeneity detection test 430 includes receiving an acoustic datastream captured by an ASD (e.g., ASD 40 shown in FIG. 1) of a well system (e.g., well system 10 shown in FIG. 1). For instance, FIG. 24 depicts a graph 440 depicting an exemplary ASD acoustic datastream 442 and a filtered or smoothed ASD acoustic datastream 442 determined from the ASD acoustic datastream 442, such as following smoothing using exponential weighting and the like. ASD acoustic datastreams 442 and 444 are captured over an extended period of time such as, in this example, several consecutive days.

At block 434, homogeneity detection test 430 includes transforming a time window selected from the acoustic datastream (e.g., ASD acoustic datastream 442 of graph 440) received at block 432 from the temporal domain (e.g., as a timeseries function) to the frequency domain (e.g., as a function of frequency) to determine an ASD frequency curve for the selected time window. The time window has a defined (e.g., user-defined) window size in some embodiments. As an example, FIG. 25 depicts a graph 450 depicting a selected time window or sample 452 obtained from the ASD acoustic datastream 442 shown in graph 440. In other words, time window 452 corresponds to a selected snippet or sample of the temporally larger ASD acoustic datastream 442. Time window 452 is presented in graph 450 in the temporal domain with the window size in this example being equal to approximately 100 seconds. As an additional example, FIG. 26 depicts a graph 460 depicting an exemplary ASD frequency curve 462 of the time window 452 shown in graph 450. In some embodiments, block 434 comprises applying a Fourier Transform such as a Fast Fourier Transform (FFT) to the selected time window whereby, for example, ASD frequency curve 462 may comprise the FFT of the time window 452 of graph 450. However, in other embodiments, alternative mathematical techniques may be employed for transforming the time window from the temporal domain to the frequency domain.

At block 436, homogeneity detection test 430 includes determining a synthetic homogenies frequency curve or datastream. Particularly, a synthetic homogenies frequency curve may be determined that is perfectly homogenous and having a peak frequency that is equal to a peak frequency of the time window. For instance, graph 460 depicts an exemplary synthetic homogenies frequency curve 464 that is based on the ASD frequency curve 462. Particularly, in this example, synthetic homogenies frequency curve 464 corresponds to the frequency curve obtained from a perfectly homogenous datastream having a peak frequency that is the same or equal to the peak frequency 463 of ASD frequency curve 462. In this example, the peak frequency 463 of ASD frequency curve 462 and a peak frequency 465 of synthetic homogenies frequency curve 464 are each approximately equal to 11 Hertz (Hz). Thus, synthetic homogenies frequency curve 464 represents a perfectly homogenized form of the ASD frequency curve 462 in at least some embodiments. In some embodiments, the synthetic homogenies frequency curve is determined based on the ASD frequency curve determined at block 434.

At block 438, homogeneity detection test 430 includes determining a homogeneity similarity score for the selected time window (e.g., time window 452 shown in graph 450) by relating the ASD frequency curve (e.g., ASD frequency curve 462 of graph 460) determined at block 434 with the synthetic homogenies frequency curve (e.g., synthetic homogenies frequency curve 464 of graph 460) determined at block 436. In some embodiments, the homogeneity similarity score corresponds to the cosine similarity between the ASD frequency curve and the synthetic homogenies frequency curve, where the homogeneity similarity score may range between 0.0 (perfectly inhomogeneous) and 1.0 (perfectly homogenous). As an example, FIG. 32 includes a graph 470 depicting an exemplary homogeneity similarity score 472 as a timeseries function and which may range between 0.0 and 1.0.

In some embodiments, blocks 434 through 438 may be repeated iteratively (indicated by arrow 439 in FIG. 23) for each successive time window of the given acoustic datastream. For instance, in the example provided in graphs 440, 450, and 460, blocks 434-438 may be performed approximately every 100 seconds as each new time window of ASD acoustic datastream 442 is captured by a given ASD according to some embodiments. In this manner, a plurality of separate and varying homogeneity similarity scores may be obtained for a single acoustic datastream such as ASD acoustic datastream 442. To provide an example, FIG. 27 depicts a graph 470 depicting an exemplary homogeneity similarity score 472 for the entirety of the ASD acoustic datastream 442. As shown in graph 470, the homogeneity similarity score 472 may vary over time as a timeseries function according to some embodiments.

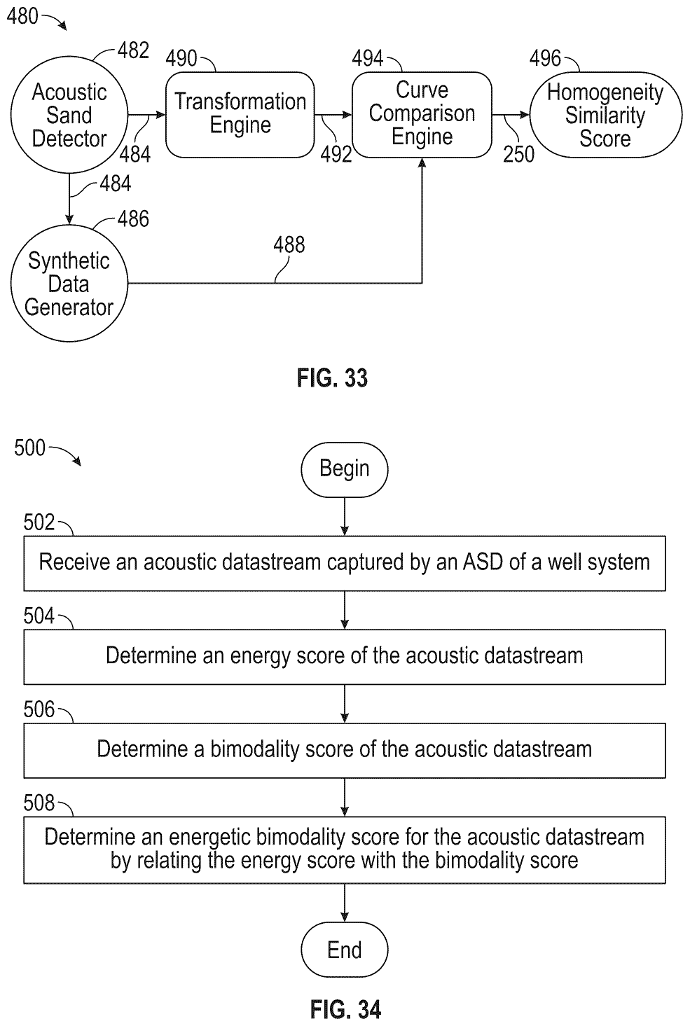

Referring to FIG. 33, an embodiment of a computer-implemented homogeneity detection system 480 is shown. Homogeneity detection system 480 is generally configured for administering homogeneity detection tests including, for example, the homogeneity detection test 430 shown in FIG. 28. In some embodiments, the homogeneity detection system 480 may comprise a component of the sand detection system 50 shown in FIG. 1 such as, for example, by the noise module 54 of sand detection system 50. In this exemplary embodiment, homogeneity detection system 480 generally includes one or more ASDs 482 that capture an ASD acoustic datastream (represented by arrow 484 in FIG. 33), a synthetic data generator 486, a transformation engine 490, and a curve comparison engine that produces a homogeneity similarity score 496 as an output of the homogeneity detection system 480.

The synthetic data generator 486 of homogeneity detection system 480 is generally configured to produce or generate a synthetic frequency function or curve (represented by arrow 488 in FIG. 33). In some embodiments, synthetic data generator 486 is configured to at least partially implement block 436 of the homogeneity detection test 430 shown in FIG. 28. For instance, the synthetic homogenies frequency curve 488 may be perfectly homogenies having a peak frequency equal to a peak frequency of the ASD acoustic datastream 484 (e.g., the peak frequency of a selected time window of the ASD acoustic datastream 484). Thus, in some embodiments, synthetic data generator 486 generates the synthetic homogenies frequency curve 488 based on the ASD acoustic datastream 484.

The transformation engine 490 of homogeneity detection system 480 determines an ASD frequency function or curve 492 using the ASD acoustic datastream 484 received from ASDs 482. In other words, transformation engine 490 converts the ASD acoustic datastream 484 from the time domain to the frequency domain such as by applying a transform to the ASD acoustic datastream 484 such as a Fourier Transform (e.g., FFT). Thus, in some embodiments, the ASD frequency curve 492 may correspond to the FFT of the ASD acoustic datastream 484 (e.g., a selected time window

The curve comparison engine 494 of homogeneity detection system 480 determines the homogeneity similarity score 496 (e.g., for a selected time window of the ASD acoustic datastream 484) based on both the synthetic homogenies frequency curve 488 produced by synthetic data generator 486 and the 492 In some embodiments, curve comparison engine 494 is configured to at least partially implement block 438 of the homogeneity detection test 430 shown in FIG. 28. In certain embodiments, curve comparison engine 494 is configured to determine the similarity such as the cosine similarity between the ASD frequency curve 492 and the synthetic homogenies frequency curve 488 to determine the homogeneity similarity score 496.

In some embodiments, the one or more noise tests administrable by the noise module 54 shown in FIG. 1 includes an energetic bimodality detection test configured to detect or identify periods or episodes of high energy bimodality in an ASD acoustic datastream. Particularly, high energy bimodality may indicate a noise event rather than a sand event in the ASD acoustic datastream such as other physical processes including slugging and/or loose and vibrating ASDs.

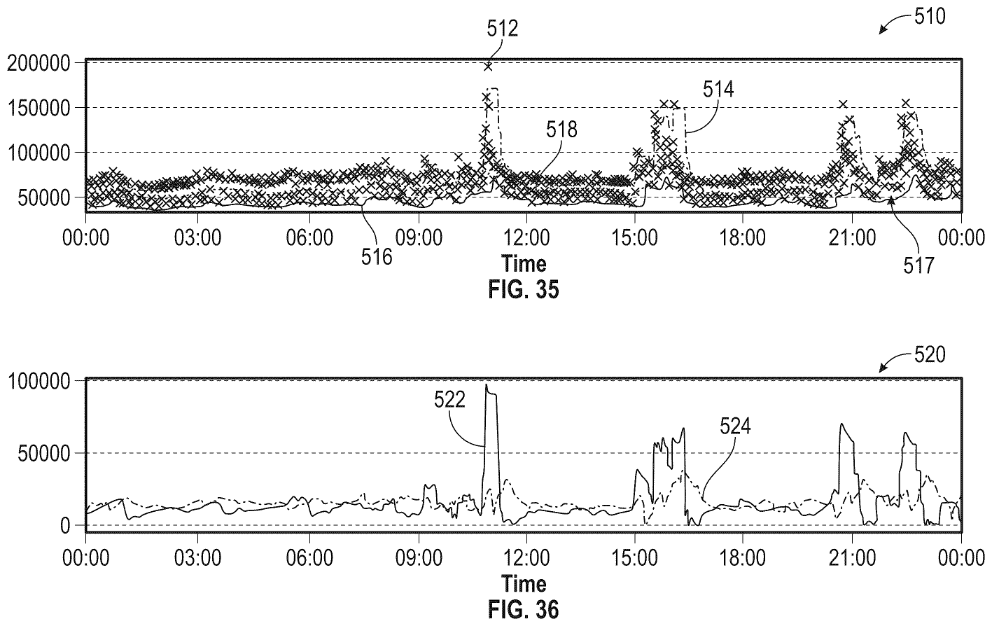

Referring to FIGS. 34-41, FIG. 34 depicts an embodiment of a method 500 for administering an energetic bimodality detection test, and which may also be referred to herein as energetic bimodality detection test 500. In some embodiments, the energetic bimodality detection test 500 may be administered by the sand detection system 50 shown in FIG. 1 including, for example, by the noise module 54 of sand detection system 50. Beginning at block 502, energetic bimodality detection test 500 includes receiving an acoustic datastream captured by an ASD (e.g., ASD 40 shown in FIG. 1) of a well system (e.g., well system 10 shown in FIG. 1). For example, FIG. 35 depicts a graph 510 depicting an exemplary ASD acoustic datastream 512 (shown in graph 510 as a plurality of separate datapoints only one of which being labeled in the interest of clarity).

At block 504, energetic bimodality detection test 500 includes determining an energy score of the acoustic datastream. In some embodiments, block 504 includes determining both a first or upper quantile acoustic datastream and a second or lower quantile acoustic datastream (e.g., both as timeseries functions) using the acoustic datastream received at block 502. Additionally, in certain embodiments, block 504 includes determining a baseline datastream (e.g., as a timeseries function) based on the acoustic datastream received at block 502 and which generally falls between the upper and lower quantile acoustic datastreams. In some embodiments, the baseline datastream comprises a filtered or smoothed acoustic datastream produced by smoothing or filtering (e.g., via exponential weighting and/or other techniques) the ASD acoustic datastream received at block 502. In certain embodiments, the baseline datastream corresponds to a rolling mean of the acoustic datastream.

In this example, a first or upper gap datastream having a magnitude which may vary with time extends between the upper quantile and a mean of the acoustic datastream received at block 502, and a second or lower gap datastream having a magnitude which also may vary with time extends between the lower quantile and the acoustic datastream mean. The magnitudes of the upper and lower gap datastreams need not be equal at a given point in time. Additionally, the magnitude of the upper and lower gap datastreams at a given point in time is zero or greater.

As an example, graph 510 of FIG. 35 depicts an exemplary upper quantile acoustic datastream 514, an exemplary lower quantile acoustic datastream 516, and a baseline datastream 518 (e.g., a smoothed acoustic datastream) sandwiched between acoustic datastreams 514 and 516. As shown in graph 510, both a first or upper gap datastream (depicted generally by arrow 515 in graph 510) and a second or lower gap datastream (depicted generally by arrow 517 in graph 510) are formed between the baseline datastream 518 and the upper quantile acoustic datastream 514 and lower quantile acoustic datastream 516, respectively. Additionally, FIG. 36 depicts a graph 520 depicting the respective magnitudes (as timeseries functions) of an upper gap datastream 522 that extends between the upper quantile acoustic datastream 514 and the acoustic datastream mean, and of a lower gap datastream 524 that extends at each point in time between the lower quantile acoustic datastream 516 and the acoustic datastream mean. As shown in graph 520, in this example, the magnitudes of upper gap datastream 522 and lower gap datastream 524 may vary independently over time with the magnitude of upper gap datastream 522 exceeding the magnitude of lower gap datastream 524 at some points in time while the magnitude of lower gap datastream 524 exceeds the magnitude of upper gap datastream 522 at other points in time.

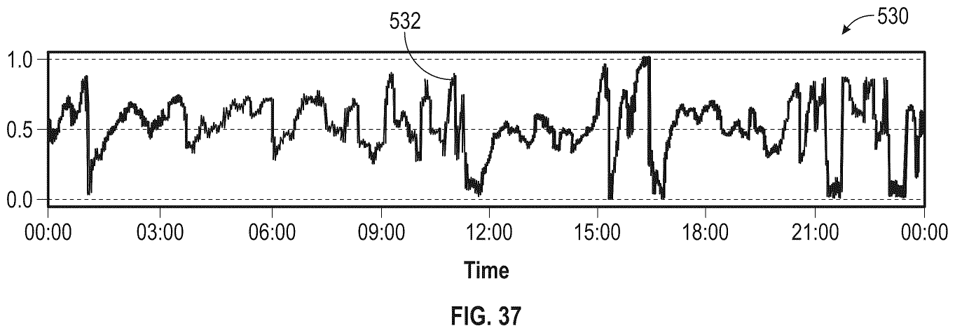

In some embodiments, block 504 includes, for different points in time, dividing the minimum of the upper gap and the lower gap datastreams at the selected point in time (e.g., the lesser of upper gap datastream 522 and lower gap datastream 524 of graph 520 at a selected point in time) by the baseline datastream for the selected point in time in order to determine a normalized energy score (e.g., falling between 0.0 and 1.0 with the amount of energy present in the datastream increasing with an increasing energy score) of the acoustic datastream received at block 502 for the selected point in time. To provide an example, FIG. 37 depicts a graph 530 depicting an energy score 532 of the ASD acoustic datastream 512 of graph 510 determined using the upper and lower gap datastreams 522 and 524, respectively, of graph 520 along with the baseline datastream 518 of graph 510. The energy score 532 depicts several spikes in energy (e.g., having an energy score substantially equal to 1.0) at different points in time which may correlate with sand or noise evens depending on the bimodality of the ASD acoustic datastream 512 at the given point in time.

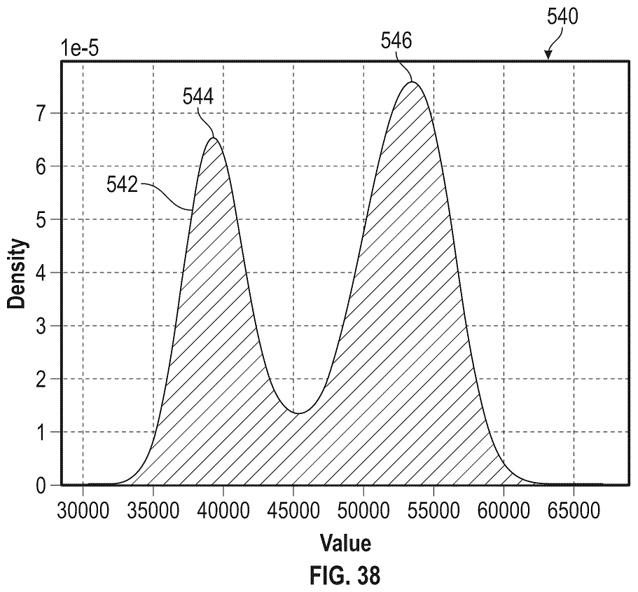

At block 506, energetic bimodality detection test 500 includes determining a bimodality score of the acoustic datastream. In some embodiments, HDT is applied to the acoustic datastream (e.g., on successive rolling windows thereof) received at block 502 in order to determine the bimodality score of the acoustic datastream (e.g., which may vary with time as a timeseries function) that identifies periods or episodes of the acoustic datastream exhibiting bimodal clustering of the energy of the acoustic datastream at the upper and lower quantiles thereof. As an illustrative example, FIG. 38 depicts a histogram 540 depicting kernel density 542 of an ASD acoustic datastream for a given point or window in time. In this example, kernel density 542 exhibits bimodal behavior including a first energy peak 544 clustered at approximately 39,000 nondenominational units or counts as described above, and a second energy peak 546 located at approximately 54,000 counts. In some embodiments, kernel density 542 is compared with a synthetic and perfectly bimodal baseline to determine the bimodality score of the ASD acoustic datastream for the given point or window in time.

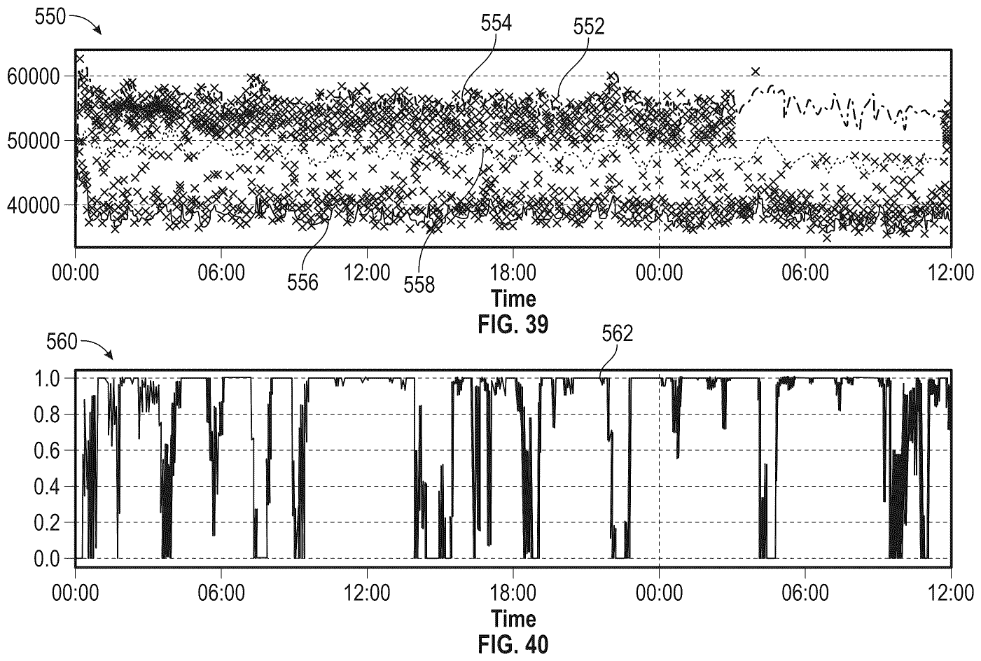

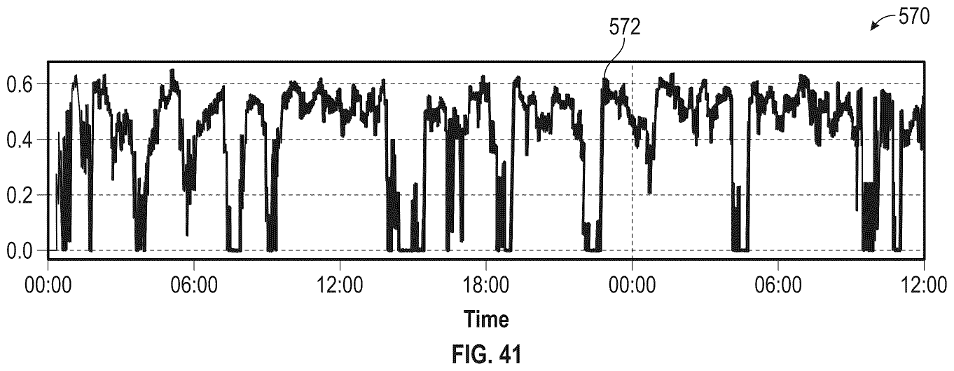

As an additional example, FIG. 39 depicts a graph 550 depicting an exemplary ASD acoustic datastream 552, an exemplary upper quantile datastream 554, an exemplary lower quantile datastream 556, and an exemplary baseline datastream 558. Further, FIG. 40 depicts a graph 560 depicting a bimodality score 562 of the ASD acoustic datastream 552 of graph 550 and based on the quantile datastreams 554, 556, and baseline datastream 558 also of graph 550. As shown in graphs 550 and 560, the bimodality score 562 of ASD acoustic datastream 552 at a given point or window in time is not be intelligible or clearly indicated from viewing the ASD acoustic datastream 552 itself.

At block 508, energetic bimodality detection test 500 includes determining an energetic bimodality score for the acoustic datastream (e.g., ASD acoustic datastream 512 of graph 510) by relating the energy score (e.g., energy score 532 of graph 530) determined at block 504 with the bimodality score. In some embodiments, the energetic bimodality score may be a timeseries function that varies over time (e.g., between 0.0 for a low energy and stable datastream and 1.0 for a high energy and bimodal datastream) in accordance with changes over time in the acoustic datastream. In certain embodiments, the energy and bimodality scores for a given point in time (or a given rolling window of a defined size) may be related through averaging the two scores, adding the two scores together, or otherwise comparing, contrasting, or combining the pair of scores.

As an example, FIG. 41 depicts a graph 570 depicting (as a timeseries function) an energetic bimodality score 572 of the ASD acoustic datastream 552 of graph 550. The energetic bimodality score 572 is based on both the bimodality score 562 of graph 560 and an energy score of the ASD acoustic datastream 552. Such behavior is indicative of non-sand events in a well system (e.g., well system 10 shown in FIG. 1) such as slugging and rattling of a loose ASD, and thus a high energetic bimodality score 572 may indicate the occurrence of a noise event, rather than a sand event, in the ASD acoustic datastream 552.

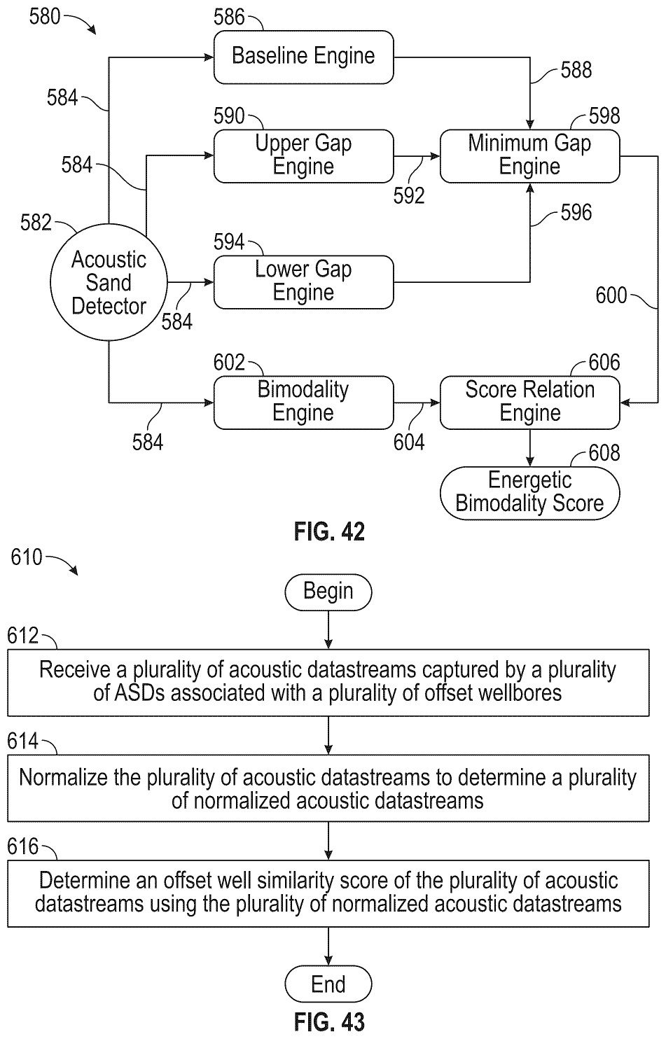

Referring to FIG. 42, an embodiment of a computer-implemented energetic bimodality detection system 580 is shown. Energetic bimodality detection system 580 is generally configured for administering energetic bimodality detection tests including, for example, the energetic bimodality detection test 500 shown in FIG. 34. In some embodiments, the energetic bimodality detection system 580 may comprise a component of the sand detection system 50 shown in FIG. 1 such as, for example, by the noise module 54 of sand detection system 50. In this exemplary embodiment, energetic bimodality detection system 580 generally includes one or more ASDs 582 that capture an ASD acoustic datastream (represented by arrow 584 in FIG. 42), a baseline engine 586, an upper gap engine 590, a lower gap engine 594, a minimum gap engine 598, a bimodality engine 602, and a score relation engine 606 that determines an energetic bimodality score 608 as an output of energetic bimodality detection system 580.

The baseline engine 586 of bimodality detection system 580 determines a baseline datastream (represented by arrow 588 in FIG. 42) from the ASD acoustic datastream 584 received from ASDs 582. In some embodiments, baseline engine 586 is configured to at least partially implement block 504 of the energetic bimodality detection test 500 shown in FIG. 34. In certain embodiments, the baseline datastream 588 is determined by baseline engine 586 by applying a smoothing function or filter (e.g., using exponential weighting and the like) to the ASD acoustic datastream 584. In certain embodiments, the baseline datastream 588 corresponds to a rolling mean of the ASD acoustic datastream 584 having a predefined (e.g., user-selected) time window.

The upper gap engine 590 of bimodality detection system 580 determines an upper gap datastream (represented by arrow 592 in FIG. 42) from the ASD acoustic datastream 584 received from ASDs 582. In some embodiments, upper gap engine 590 is also configured to at least partially implement block 504 of the energetic bimodality detection test 500 shown in FIG. 34. In some embodiments, the upper gap datastream 592 corresponds to the magnitude or difference between an upper quantile and a mean of the ASD acoustic datastream 584 as determined by the upper gap engine 590.

The lower gap engine 594 of bimodality detection system 580 determines a lower gap datastream (represented by arrow 596 in FIG. 42) from the ASD acoustic datastream 584 received from ASDs 582. In some embodiments, lower gap engine 594 is also configured to at least partially implement block 504 of the energetic bimodality detection test 500 shown in FIG. 34. In certain embodiments, the lower gap datastream 596 corresponds to the magnitude or difference between a lower quantile and the mean of the ASD acoustic datastream 584 as determined by the lower gap engine 594.

The minimum gap engine 598 of bimodality detection system 580 determines an energy score (represented by arrow 600 in FIG. 42) from each of the baseline datastream 588, upper gap datastream 592, and lower gap datastream 596. In some embodiments, minimum gap engine 598 is also configured to at least partially implement block 504 of the energetic bimodality detection test 500 shown in FIG. 34. In some embodiments, the energy score 600 corresponds to the ratio of a minimum of the upper gap datastream 592 and lower gap datastream 596 and the baseline datastream 588. Additionally, the energy score 600 is provided by the minimum gap engine 598 to the score relation engine 606.

As an example, if the magnitude of upper gap datastream 592 at a particular point in time (or across a selected time window) is less than the magnitude of lower gap datastream 596 at the same point in time (or across the same selected time window), then the energy score 600 for the particular point in time/selected time window corresponds to the ratio of the upper gap datastream 592 to the baseline datastream 588 at the particular point in time/selected time window. Conversely, if the magnitude of upper gap datastream 592 at a particular point in time (or across a selected time window) is greater than the magnitude of lower gap datastream 596 at the same point in time (or across the same selected time window), then the energy score 600 for the particular point in time/selected time window corresponds to the ratio of the lower gap datastream 596 to the baseline datastream 588 at the particular point in time/selected time window

The bimodality engine 602 of bimodality detection system 580 determines a bimodality score (represented by arrow 604 in FIG. 42) from the ASD acoustic datastream 584 received from ASDs 582. In some embodiments, bimodality engine 602 is configured to at least partially implement block 506 of the energetic bimodality detection test 500 shown in FIG. 34. In certain embodiments, bimodality engine 602 applies a bimodality test such as HDT, for example, to the ASD acoustic datastream 584 to determine the bimodality score 604. In this manner, the bimodality score 604 may identify periods or episodes of ASD acoustic datastream 584 exhibiting bimodal energy clustering.

In this exemplary embodiment, the score relation engine 606 of energetic bimodality detection system 580 relates the energy score 600 determined by minimum gap engine 598 with the bimodality score 604 determined by bimodality engine 602 in order to determine the energetic bimodality score 608. In other embodiments, energy score 600, bimodality score 604, and/or other scores independently or in combination may be taken as the energetic bimodality score 608. In certain embodiments, score relation engine 606 is configured to at least partially implement block 508 of the energetic bimodality detection test 500 shown in FIG. 34. For instance, according to a predefined (e.g., user-selected) rule of score relation engine 606, the score relation engine 606 may combine or compare the energy score 600 and the bimodality score 604 when determining the energetic bimodality score 608.

In some embodiments, the one or more noise tests administrable by the noise module 54 shown in FIG. 1 includes an offset well similarity detection test configured to detect or identify periods or episodes of similarity in temporally correlated ASD acoustic datastreams for a pair of separate wellbores or well systems (e.g., separate wellbores 20 of one or more well systems 10 of FIG. 1). Particularly, external sources of noise (e.g., beyond noise generated by formation materials or fluids themselves interacting with equipment of the well system) may, in some instances, generate signatures that may be identified in a plurality of adjacent or neighboring offset wellbores. As an example, in offshore applications, remotely operated underwater vehicles (ROVs) may generate noise having a signature that may be identified concurrently in several neighboring wellbores. Thus, similarities in acoustic datastreams of adjacent or neighboring offset wellbores may be used to detect or identify such non-sand related external sources of noise to exclude or otherwise account for these external sources of noise (e.g., as identifying them as noise events).

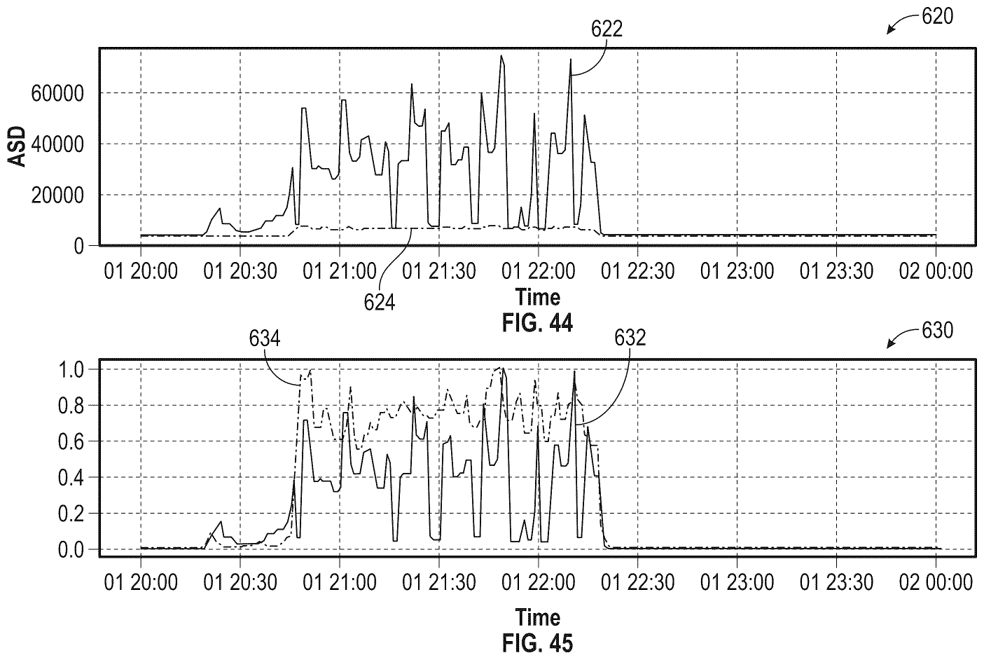

Referring to FIGS. 43-48, FIG. 43 depicts an embodiment of a method 610 for administering an offset well similarity detection test, and which may also be referred to herein as offset well similarity detection test 610. In some embodiments, the offset well similarity detection test 610 may be administered by the sand detection system 50 shown in FIG. 1 including, for example, by the noise module 54 of sand detection system 50. Beginning at block 612, offset well similarity detection test 610 includes receiving a plurality of acoustic datastreams captured by a plurality of ASDs (e.g., ASD 40 shown in FIG. 1) associated with a plurality of offset wellbores. The plurality of offset wellbores may be associated with a plurality of separate well systems or a single well system (e.g., well system 10 shown in FIG. 1). As an example, FIG. 44 depicts a graph 620 depicting an exemplary first ASD acoustic datastream 622 associated with a first wellbore and an exemplar second ASD acoustic datastream 624 associated with a separate, second wellbore that is offset from the first wellbore.

At block 614, offset well similarity detection test 610 includes normalizing the plurality of acoustic datastreams (e.g., ASD acoustic datastreams 622 and 624) received at block 612 to determine a plurality of normalized acoustic datastreams. In some embodiments, block 614 comprises determining a plurality of normalized acoustic datastreams by subtracting the acoustic datastreams received at block 612 by corresponding filtered or smoothed (e.g., using exponential weighting and the like) acoustic datastreams. As an example, corresponding FIG. 45 depicts a graph 630 including a normalized acoustic datastream 632 determined from the ASD acoustic datastream 622 (and thus associated with the same first wellbore as ASD acoustic datastream 622), and a normalized acoustic datastream 634 determined from the ASD acoustic datastream 624 (and thus associated with the same second wellbore as ASD acoustic datastream 624). In addition to being normalized, normalized acoustic datastreams 632 and 634 are each scaled between arbitrary units of 0.0 and 1.0.

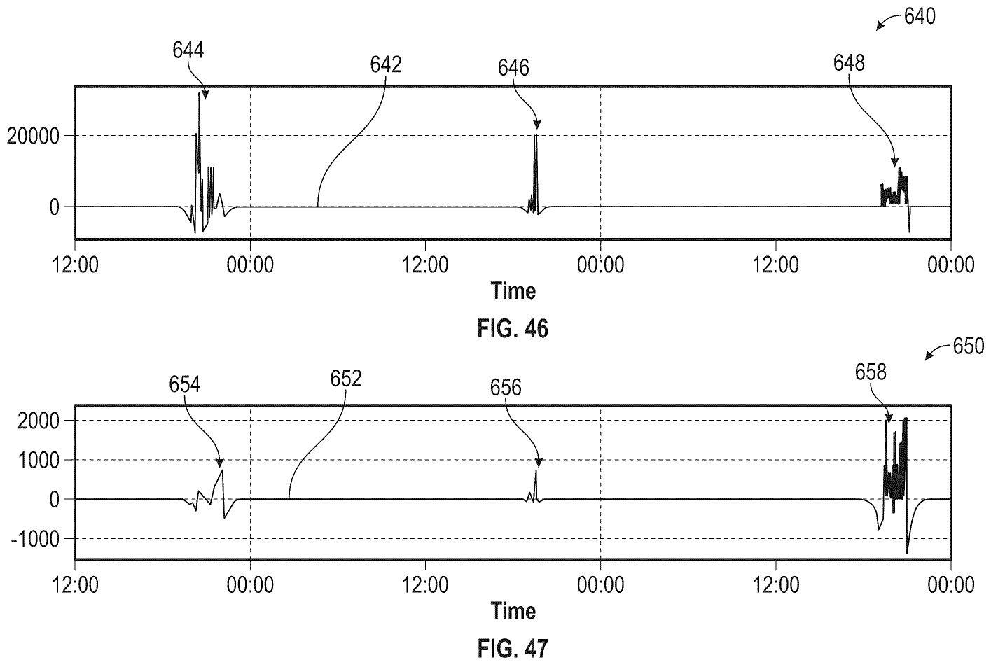

As another example, FIG. 46 depicts a graph 640 depicting a normalized acoustic datastream 642 of another, third wellbore, and FIG. 47 similarly depicts a graph 650 depicting a normalized acoustic datastream 652 of a further, fourth wellbore that is offset from the third wellbore. In this example, normalized acoustic datastreams 642 and 652 are shown in graphs 640 and 650, respectively, prior to being scaled between 0.0 and 1.0. Additionally, normalized acoustic datastreams 642 and 652 may be obtained from ASD acoustic datastreams associated with the third and fourth wellbores, respectively. Each of normalized acoustic datastreams 642 and 652 capture a plurality of temporally spaced events labeled as events 644, 646, and 648 in graph 640 and events 654, 656, and 658 in graph 650 where the two sets of events are roughly correlated in time (e.g., a first event 644 of graph 640 was captured at roughly the same time as first event 654 of graph 650 and so on and so forth).

At block 616, offset well similarity detection test 610 includes determining an offset well similarity score of the plurality of acoustic datastreams received at block 612 using the plurality of normalized acoustic datastreams determined at block 614. The offset well similarity score may apply or correspond to each of the separate normalized acoustic datastreams included in the comparison. In certain embodiments, the offset well similarity score is determined on a rolling basis by segmenting the plurality of normalized acoustic datastreams into separate time windows each having a predefined (e.g., user-defined) size such that an offset well similarity score is determined for each successive time window on a rolling basis.

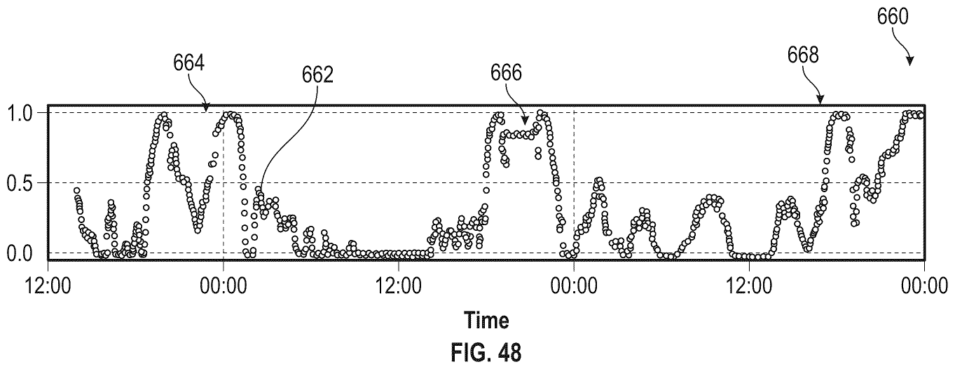

In some embodiments, the offset well similarity score comprises a correlation coefficient indicative of the degree of correlation between the plurality of normalized acoustic datastreams. For instance, the correlation coefficient may comprise a linear correlation coefficient such as the Pearson correlation coefficient. However, the type of correlation coefficient used may vary depending on the given application. As an example, FIG. 48 depicts a graph 660 depicting an offset well similarity score 662 for the pair of normalized acoustic datastreams 642 and 652 shown in graphs 640 and 650, respectively. Thus, offset well similarity score 662 is associated with both the third and fourth wellbores from which normalized acoustic datastreams 642 and 652 were originally captured as raw or ASD acoustic datastreams.

As shown in graph 660, the points in time correlated with the events 644, 646, 648/654, 656, and 658 captured in graphs 640 and 650 correlate with episodes 664 of high offset well similarity (e.g., where the offset well similarity score approaches 1.0), indicating that the events 644, 646, 648/654, 656, and 658 may, instead of being indicative of sand event in the third and fourth wellbores, are instead indicative of correlated noise events such as the operation of a ROV proximal the third and fourth wellbores.

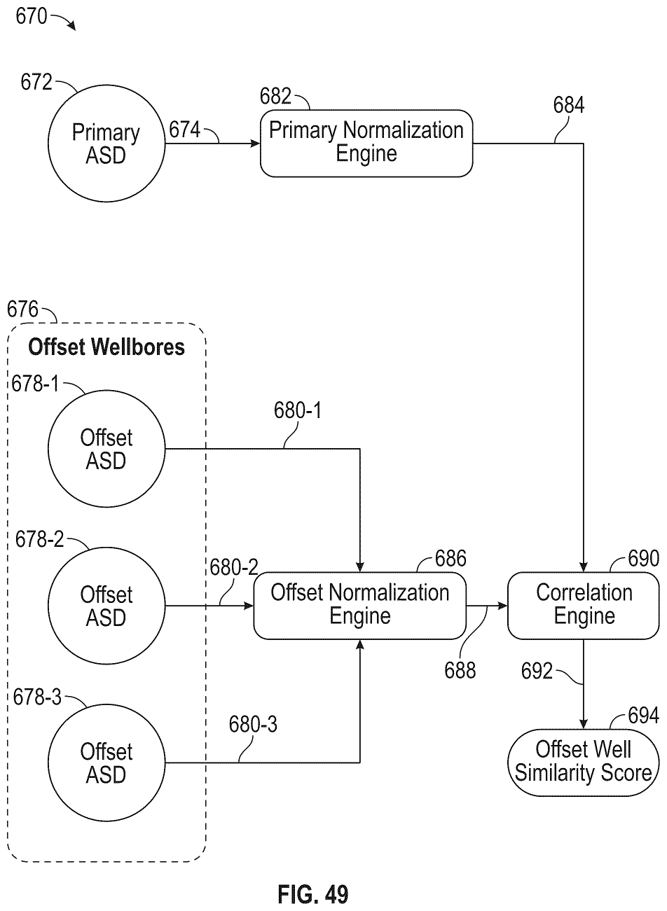

Referring to FIG. 49, an embodiment of a computer-implemented offset well similarity detection system 670 is shown. Offset well similarity detection system 670 is generally configured for administering offset well similarity detection tests including, for example, the offset well similarity detection test 610 shown in FIG. 43. In some embodiments, the offset well similarity detection system 670 may comprise a component of the sand detection system 50 shown in FIG. 1 such as, for example, by the noise module 54 of sand detection system 50. In this exemplary embodiment, offset well similarity detection system 670 generally includes one or more primary ASDs 672 that capture a primary ASD acoustic datastream (represented by arrow 674 in FIG. 49) a plurality of offset ASDs 678 associated with a plurality of separate offset wellbores 676, a primary normalization engine 682, an offset normalization engine 686, and a correlation engine 690,

The primary normalization engine 682 of offset well similarity detection system 670 normalizes the primary ASD acoustic datastream 674 received from primary ASD 672 to produce a normalized primary datastream 684. In some embodiments, primary normalization engine 682 is configured to at least partially implement block 614 of the offset well similarity detection test 610 shown in FIG. 43. In certain embodiments, primary normalization engine 682 initially determines a smoothed datastream from the primary ASD acoustic datastream 674 which may comprise, for example, a rolling mean of the primary ASD acoustic datastream 674. Additionally, the primary normalization engine 682 may determine the normalized primary datastream 684 by subtracting the smoothed datastream from the primary ASD acoustic datastream 674. In certain embodiments, techniques such as exponential weighting may also be applied. However, the configuration of primary normalization engine 682 may vary in other embodiments.

Offset ASDs 678 (shown as 678-1, 678-2, and 678-3 in FIG. 49 corresponding to three separate offset wellbores) of offset well similarity detection system 670 672 capture a corresponding plurality of offset ASD acoustic datastreams (represented by arrows 680-1, 680-2, and 680-3 in FIG. 49). Although offset well similarity detection system 670 is shown in FIG. 49 as comprising three separate offset wellbores/offset ASDs 678, in other embodiments, offset well similarity detection system 670 may include only a single offset wellbore/offset ASD or any other number of offset wellbores/offset ASDs.

The offset normalization engine 686 of offset well similarity detection system 670 normalizes the offset ASD acoustic datastreams 680 received from offset ASDs 678 to produce a normalized offset datastream 688. In some embodiments, offset normalization engine 686 is configured to at least partially implement block 614 of the offset well similarity detection test 610 shown in FIG. 43. In certain embodiments, offset normalization engine 686 initially determines a smoothed datastream for each of the offset ASD acoustic datastreams 680 which may comprise, for example, rolling means of the offset ASD acoustic datastreams 680. Additionally, the offset normalization engine 686 may determine the offset primary datastream 688 by subtracting the smoothed datastreams from the corresponding offset ASD acoustic datastreams 680. Although shown as a single normalized offset datastream 688 in FIG. 49, the normalized offset datastream 688 may correspond to or incorporate a plurality of separate normalized offset datastreams 688 each corresponding to a unique offset ASD acoustic datastream 680. In certain embodiments, techniques such as exponential weighting may also be applied. However, the configuration of offset normalization engine 686 may vary in other embodiments.

The correlation engine 690 relates (e.g., compares) the primary normalized datastream 684 received from primary normalization engine 682 with the offset normalized datastream 688 received from offset normalization engine 686 to determine the offset well similarity score 694 in the form of a correlation coefficient 692. The correlation coefficient 692 determined from datastreams 684 and 688 may comprise a linear coefficient such as a Pearson correlation coefficient and thus, in some embodiments, correlation engine 690 may determine a Pearson correlation coefficient between datastreams 684 and 688. However, in other embodiments, the configuration of correlation engine 690 may vary.

In some embodiments, the one or more noise tests administrable by the noise module 54 shown in FIG. 1 includes a choke instability detection test configured to detect or identify periods or episodes of poor choke instability or quality of an ASD acoustic datastream. Such episodes of poor choke instability that could affect the efficacy of sand detection system 50 shown in FIG. 1. Particularly, movement of the choke (e.g., production choke 30 of well system 10 shown in FIG. 1) may inject noise or otherwise affect the ASD acoustic datastreams obtained from ASDs of the well systems for those period when the choke is in motion (e.g., moving towards a closed position or open position of the choke). This noise present in the ASD acoustic datastreams due to choke instability (e.g., choke motion picked up by one or more ASDs) comprise noise events that may obscure the occurrence of a sand event or lead to a false positive indication of a nonexistent sand event if not excluded or otherwise accounted for. The choke instability detection test 700 is generally configured to detect or identify periods or episodes of choke instability in the well system from which the ASD acoustic datastream is captured.

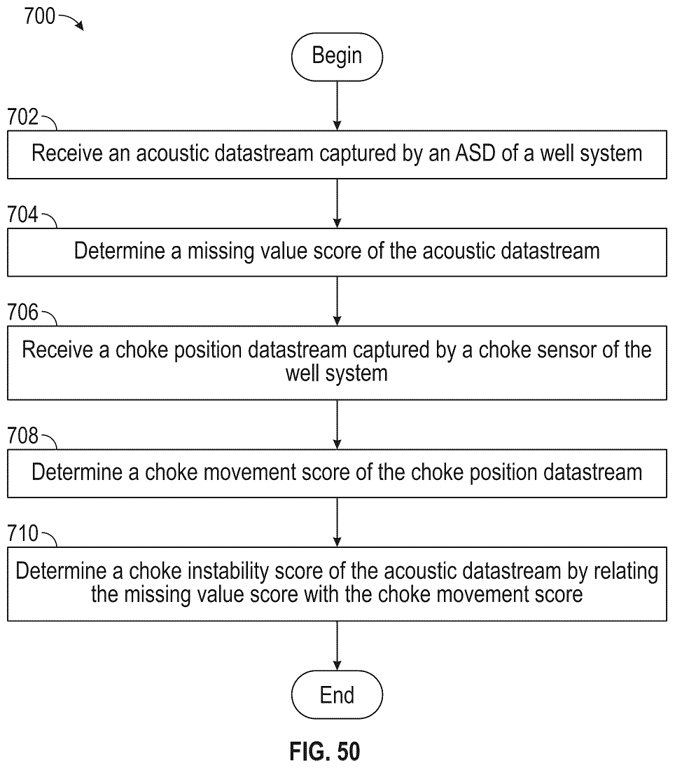

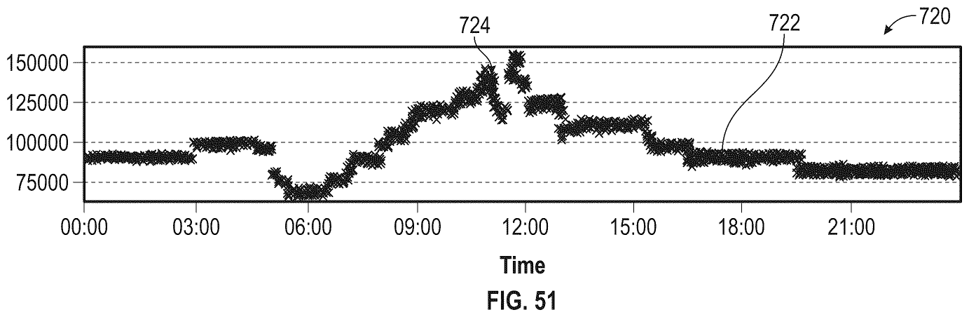

Referring to FIGS. 50-55, FIG. 50 depicts an embodiment of a method 700 for administering a choke instability detection test, and which may also be referred to herein as choke instability detection test 700. In some embodiments, the choke instability detection test 700 may be administered by the sand detection system 50 shown in FIG. 1 including, for example, by the noise module 54 of sand detection system 50. Beginning at block 702, choke instability detection test 700 includes receiving an acoustic datastream captured by an ASD (e.g., ASD 40 shown in FIG. 1) of a well system (e.g., well system 10 shown in FIG. 1). For instance, FIG. 51 depicts a graph 720 depicting an exemplary ASD acoustic datastream 722 (indicated in graph 720 as a plurality of separate datapoints only one of which is labeled for clarity) captured by an ASD such as the ASD 40 of well system 10 shown in FIG. 1. In certain embodiments, block 702 includes receiving an acoustic datastream similar to the ASD acoustic datastream 722 shown in graph 720 In this example, the ASD acoustic datastream 282 includes several missing values 724. In this context, missing value refers to a missing or absent datapoint of a datastream in view of a sampling rate of the sensor generating the datastream.

At block 704, choke instability detection test 700 includes determining a missing value score of the acoustic datastream received at block 702. In some embodiments, the missing value score may be a timeseries function that varies over time in accordance with changes over time in the acoustic datastream. Additionally, the missing value score may identify episodes of missing values or datapoints in the acoustic datastream in view of a sampling rate of the ASD from which the acoustic datastream is captured. In some embodiments, the missing value score may be determined in a manner similar to the missing value score determined at block 356 of the data fitness test 350 shown in FIG. 21. For instance, the missing value score determined at block 704 may range between 0.0 and 1.0, where the score of 0.0 is returned for a given period in time when a predefined number of consecutive values or datapoints of the acoustic datastream are identified as missing but otherwise returns a score of 1.0.

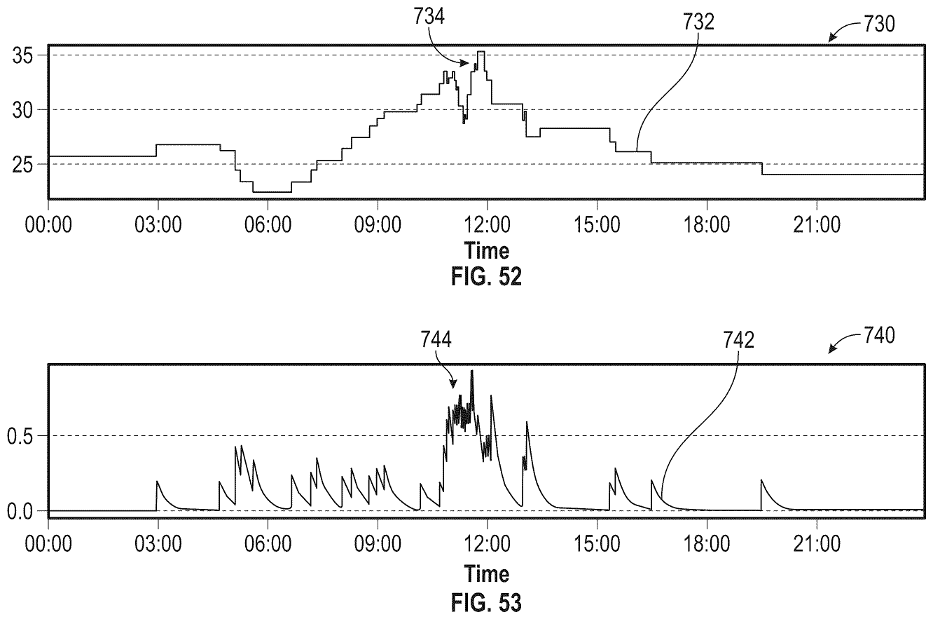

At block 706, choke instability detection test 700 includes receiving a choke position datastream by a choke sensor (e.g., the choke sensor 32 of well system 10 shown in FIG. 1) of the well system. The choke position datastream may be received in real-time or near real-time or as batch data depending on the particular application. The choke position datastream may indicate a position of the choke between its fully open and fully closed positions at different points in time. For instance, FIG. 52 depicts a graph 730 depicting an exemplary choke position (e.g., in terms of percentage open) datastream 732 indicating the position of a production choke (e.g., production choke 30 shown in FIG. 1) over time captured by the choke sensor. In this example, choke position datastream 732 indicates movement of the choke (indicated generally by arrow 734 in FIG. 52) roughly correlated with changes in the ASD acoustic datastream 722 shown in graph 720.

At block 708, choke instability detection test 700 includes determining a choke movement score of the choke position datastream received at block 706. In some embodiments, the choke movement score is binary with a 0.0 score indicating the production choke is currently stationary while a 1.0 score indicates the production choke is currently in motion. Alternatively, an instantaneous velocity or speed of the production choke may be determined using the choke position datastream 732 of graph 730 and scaled between 0.0 (zero motion) and 1.0 (maximum speed of the production choke).

At block 710, choke instability detection test 700 includes determining a choke instability score of the acoustic datastream received at block 702 by relating the missing value score determined at block 704 with the choke movement score determined at block 708. In some embodiments, the choke instability score may be a timeseries function that varies over time (e.g., between 0.0 for a substantially zero instability and 1.0 for high choke instability) in accordance with changes over time in the acoustic datastream. In certain embodiments, the missing value fitness and choke movement scores for a given point in time (or a given rolling window of a defined size) may be related through averaging the two scores, adding the two scores together, or otherwise comparing, contrasting, or combining the pair of scores.

To provide an example, FIG. 53 depicts a graph 740 depicting (as a timeseries function) a choke instability score 742 of the ASD acoustic datastream 722 of graph 720. The choke instability score 742 is based on both the missing values 724 shown in graph 720 and the choke position datastream 732 shown in graph 730. As shown in graph 740, in this example, the choke instability score 742 includes a peak 744 temporally correlated with the choke movement 734 of graph 730 and the missing values 724 of graph 720 indicating the occurrence of a noise event in the ASD acoustic datastream 722 in the form of a period or episode of choke instability.

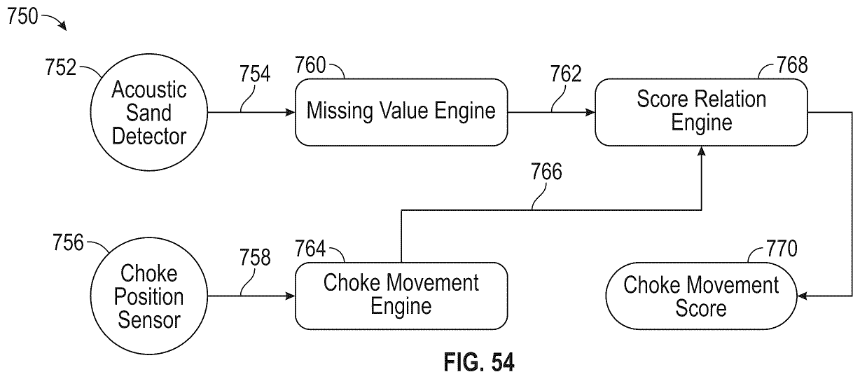

Referring to FIG. 54, an embodiment of a choke stability detection system 750 is shown. Choke stability detection system 750 is generally configured for administering choke stability detection tests including, for example, the choke stability detection test 700 shown in FIG. 50. In some embodiments, the choke stability detection system 750 may comprise a component of the sand detection system 50 shown in FIG. 1 such as, for example, by the noise module 54 of sand detection system 50. In this exemplary embodiment, choke stability detection system 750 generally includes one or more ASDs 752 configured to capture an ASD acoustic datastream (represented by arrows 754 in FIG. 50), a missing value engine 760, a choke movement engine 764, and a score relation engine 768 configured to determine a choke movement score 770 as an output of the choke stability detection system 750.

The missing value engine 760 of choke stability detection system 750 receives the ASD acoustic datastream 754 from ASDs 752 and determines a missing value score (represented by arrow 762 in FIG. 54) therefrom. In some embodiments, missing value engine 760 is configured to at least partially implement block 704 of the choke stability detection test 700 shown in FIG. 50. Additionally, in certain embodiments, missing value engine 760 is configured similarly as the missing value engine 416 shown in FIG. 27 and thus may identify consecutive missing values or datapoints in the ASD acoustic datastream 754.

The choke position sensor 756 of choke stability detection system 750 captures a choke position datastream 758 of a production choke (e.g., production choke 30 shown in FIG. 1) of a wellbore or well system monitored by the choke stability detection system 750 and which is indicative of the current (e.g., most recently sampled) position of the choke between its fully open and fully closed positions. In some embodiments, choke position sensor 756 is configured similarly as the choke sensor 32 of well system 10 shown in FIG. 1

The choke movement engine 764 of choke stability detection system 750 receives the choke position datastream 758 and determines a choke movement score 766 therefrom. In some embodiments, choke movement engine 764 is configured to at least partially implement block 708 of the choke stability detection test 700 shown in FIG. 50. In certain embodiments, the choke movement score 766 is correlated with the degree (e.g., speed) of motion of the production choke as indicated by changes in the choke position datastream 758 over time. For instance, the choke movement score 766 may be binary indicating whether the choke is currently stationary or in motion, or may provide a range of delimited values (e.g., values between 0.0 and 1.0) indicative of the current speed of the choke.

In this exemplary embodiment, the score relation engine 768 of choke stability detection system 750 relates the missing value score 762 with the choke movement score 766 to determine the choke movement score 770. In other embodiments, missing value score 762, choke movement score 766, and/or other scores independently or in combination may be taken as the choke movement score 770. In certain embodiments, score relation engine 768 is configured to at least partially implement block 358 of data fitness test 350 shown in FIG. 21. For instance, according to a predefined (e.g., user-defined) rule of score relation engine 768, the score relation engine 768 may combine or compare the missing value score 762 and the choke movement score 766 when determining the choke movement score 770.

As described above, one or more sand test scores may be related to determine an overall sand score of a well system (e.g., well system 10 shown in FIG. 1) or a specific wellbore thereof (e.g., wellbore 20 shown in FIG. 1) for a given point in time (or a given window of time having a defined window size). Additionally, in some embodiments, one or more sand test scores may be related together along with one or more additional noise test scores to determine the overall sand score. In certain embodiments, the overall sand score is based on at least each of the sand tests (e.g., anomaly detection test 80 shown in FIG. 2, positive skew detection test 190 shown in FIG. 10) and each of the noise tests (e.g., baseline jump detection test 260 shown in FIG. 15, data fitness test 350 shown in FIG. 21, homogeneity detection test 430 shown in FIG. 28, energetic bimodality detection test 500 shown in FIG. 34, offset well similarity detection test 610 shown in FIG. 43, and choke instability detection test 700 shown in FIG. 50). Each of the sand tests can only contribute positively or increase (depending on the magnitude of the sand test score of the given sand test) the overall sand score while each of the noise tests can only contribute negatively or decrease (depending on the magnitude of the noise test score of the given noise test). In other embodiments, only a subset of the sand tests and/or noise tests described herein may be used to determine the overall sand score depending on the needs and requirements of the given application.

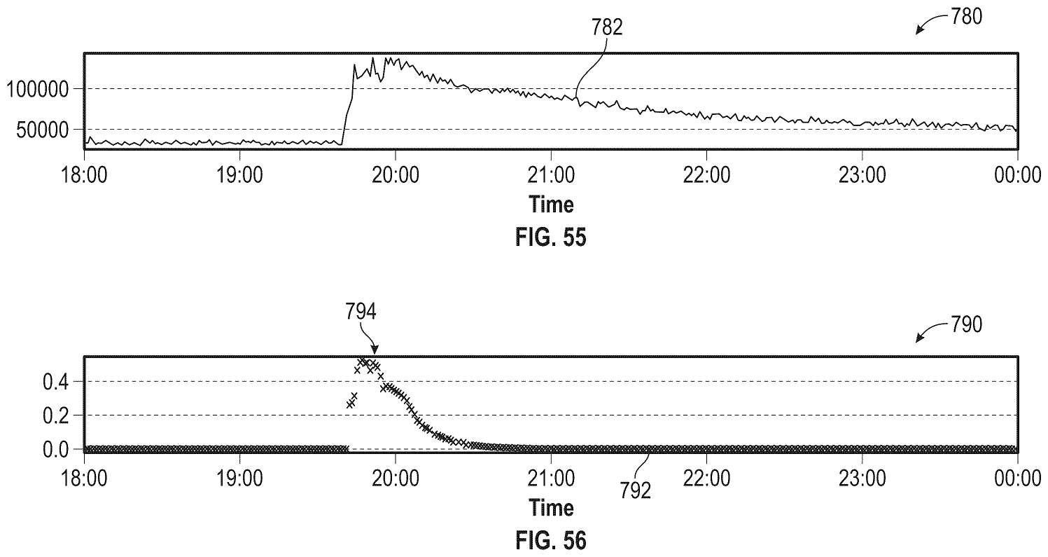

To provide an example, and referring now to FIGS. 55-62, FIG. 55 depicts a graph 780 depicting an exemplary ASD acoustic datastream 782 captured by an ASD of a well system such as the ASD 40 of well system 10 shown in FIG. 1. Additionally, FIG. 56 depicts a graph 790 depicting an exemplary overall sand score 792 that is based on the ASD acoustic datastream 782 of graph 780. For instance, overall sand score 792 may be determined by applying each of the sand tests and noise tests described herein to the ASD acoustic datastream 782. In this example, the overall sand score 792 may range between 0.0 and 1.0 where a score of 0.0 indicates an extreme unlikelihood of the occurrence of a sand event for the given well system at a given point or window of time while a score of 1.0 indicates an extreme likelihood of the occurrence of a sand event for the well system at the point or window of time. In some embodiments, a user may define a sand score threshold which, if equaled or exceeded by the overall sand score (e.g., overall sand score 792 of graph 790), may automatically and in real- or near real-time, trigger an action associated with the well system such as issuing an alarm to operators of the well system and/or adjusting one or more operational parameters of the well system (e.g., via remotely opening or closing valves, remotely adjusting the operation of powered equipment such as rotary equipment and the like) to automatically address the detection of the sand event. For instance, in this example, a user-defined sand score threshold equal to 0.4 could result in the triggering of an alarm and/or other actions given that a peak 794 of overall sand score 792 exceeds the 0.4 threshold.

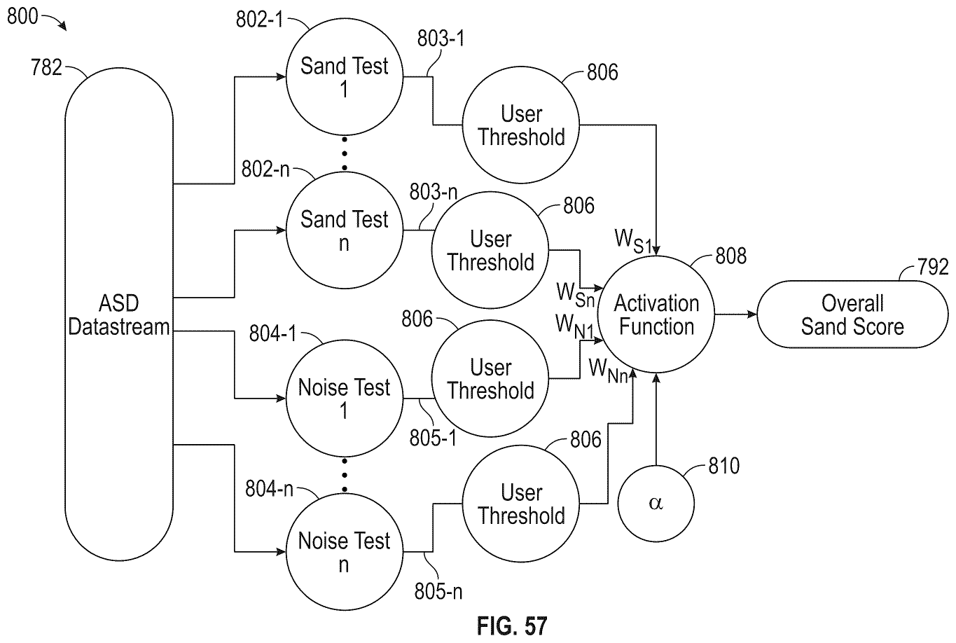

In some embodiments, an activation or transfer function is used to relate the different inputs (e.g., the exemplary sand and noise tests described herein) of a given sand detection system (e.g., sand detection system 50 shown in FIG. 1) whereby the different inputs may be selectably transformed or tuned in accordance with preferences by a user of the sand detection system. In other words, in some embodiments, the sand detection system (e.g., sand detection system 50) may incorporate one or more activation functions for determining an overall sand score. For instance, FIG. 57 depicts an embodiment of a computer-implemented sand detection system 800 that includes an activation function 808 configured to generate an output in the form of overall sand score 792 of graph 790 using ASD acoustic datastream 782 of graph 780 as an input thereof.

In this exemplary embodiment, sand detection system 800 includes one or more sand tests 802 (depicted as sand test 802-1 through sand test 802-n in FIG. 57) and one or more noise tests 804 (depicted as noise test 804-1 through noise test 804-n in FIG. 57). The activation function 808 of sand detection system 800 may be linear in some embodiments and nonlinear in other embodiments. For instance, in an embodiment, activation function 808 may comprise a nonlinear activation function such as, for example, a logistic or sigmoid function, a hyperbolic tangent (tanh) function, and a rectified linear unit (ReLU) function, and the like.

In this exemplary embodiment, each of the different sand test scores 803 and noise test scores 805 may be individually or independently weighted via predefined (e.g., user-defined) weights depicted in FIG. 57 as sand test score weights W_{S1} through W_{Sn} and noise test score weights W_{N1} through W_{Nn}. Additionally, in this exemplary embodiment, an individually or independently tunable user threshold 806 is applied to each of the sand test scores 803 and noise test scores 805 provided to the activation function 808. The user threshold may be utilized by a user of sand detection system 800 to adjust a pivot or activation threshold for the respective input defining an inflection or pivot point for the activation function 808 with respect to the specific input such that different inputs (e.g., different sand tests 802 and/or noise tests 804 may have different, tunable inflection points. In this manner, user thresholds 806 provide a tunable filter configured to generally (but not necessarily entirely) filter out or exclude test scores falling below the given user threshold 806. In other words, user thresholds 806 act as high-pass filters (which may or may not be leaky) setting individual minimum scores that must generally be achieved in order to be passed on to the activation function 808. Further, although user thresholds 806 are shown in FIG. 57 as external or separate from activation function 808, in some embodiments, each of the user thresholds 806 may be incorporated into the activation function 808. Further, in this exemplary embodiment, activation function 808 receives as an input a user-defined tuning parameter 810 that may be used to tune the response (e.g., slope, curvature, and/or other geometric properties) of the activation function 808. The configuration of activation function 808 and sand detection system 800 may vary in other embodiments. For example, in other embodiments, sand detection system 800 may not include individual weighting, user thresholds 806, and/or tuning parameter 810.

In certain embodiments, activation function 808 comprises a smoothed nonlinear function such as a smoothed ReLU function.

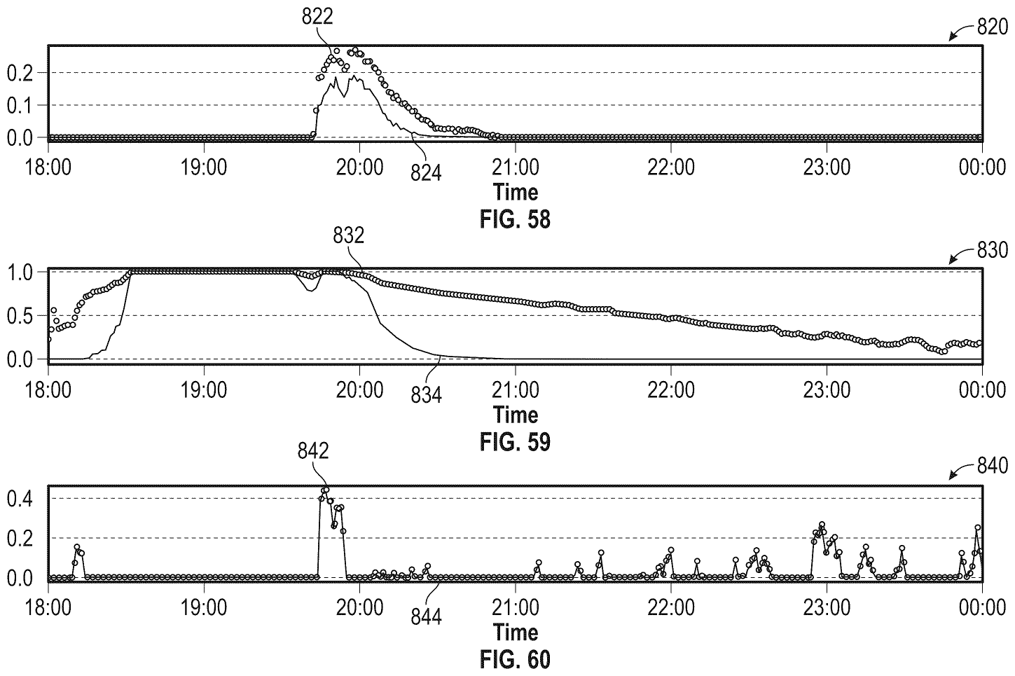

To provide an example, FIG. 58 depicts a graph 820 that depicts an exemplary ASD anomaly multiplier 822 presented as a timeseries function or datastream and which may be obtained from the ASD acoustic datastream 782 of graph 780 using, for example, the methodology described above with respect to anomaly detection test 80 shown in FIG. 2. Additionally, graph 820 depicts a translated anomaly multiplier 824 comprising an output of an activation function (e.g., activation function 808) based on ASD anomaly multiplier 822. Particularly, in this example, a relatively low user threshold of 0.1 is applied to the ASD anomaly multiplier 822. The relatively low user threshold applied in this example results in the translated anomaly multiplier 824 having a similar waveform as the ASD anomaly multiplier 822 itself.

As another example, FIG. 59 depicts a graph 830 depicting an exemplary ASD anomaly percentile 832 presented as a timeseries function or datastream and which may be obtained from the ASD acoustic datastream 782 of graph 780 using, for example, the methodology described above with respect to anomaly detection test 80 shown in FIG. 2. Additionally, graph 830 depicts a translated anomaly percentile 834 comprising an output of an activation function (e.g., activation function 808) based on ASD anomaly percentile 832. Particularly, in this example, a relatively high user threshold of 0.8 is applied to the ASD anomaly percentile 832 resulting in a significantly greater divergence in the waveforms of the translated anomaly percentile 834 and the ASD anomaly percentile 832 from which it is based.

As a further example, FIG. 60 depicts a graph 840 depicting an exemplary positive skew score 842 presented as a timeseries function or datastream and which may be obtained from the ASD acoustic datastream 782 of graph 780 using, for example, the methodology described above with respect to the positive skew detection test 190 shown in FIG. 10. Additionally, graph 840 depicts a translated positive skew score 844 comprising an output of an activation function (e.g., activation function 808) based on positive skew score 842. In this example, a user threshold has not been applied (e.g., the threshold equals 0.0) in determining translated positive skew score 844 resulting in the translated positive skew score 844 generally mirroring the positive skew score 842 from which it is based.

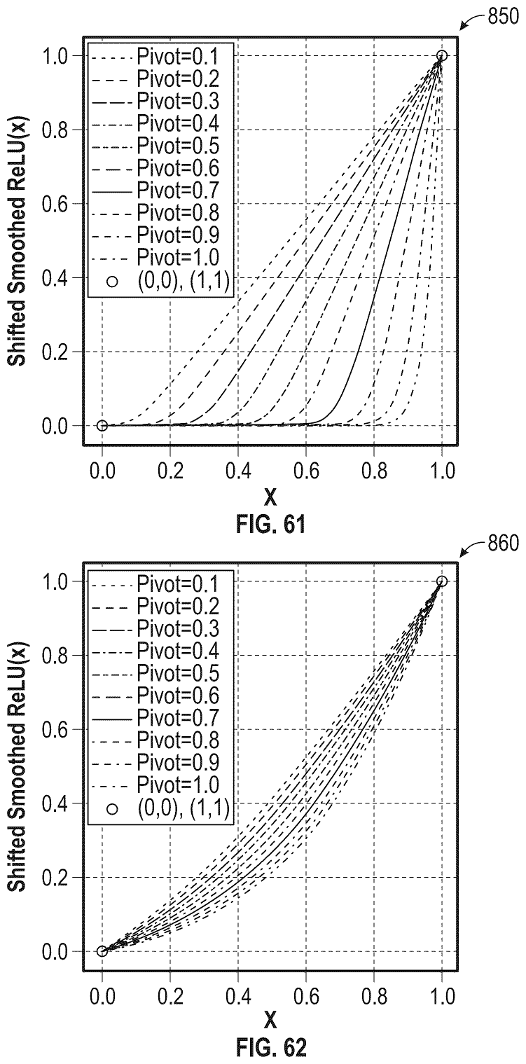

In addition, FIG. 61 depicts a graph 850 depicting the impact of adjusting the user threshold of an activation function (e.g., user thresholds 806 of activation function 808) as shown in graph 850 with the different user thresholds labeled as “Pivots” in graph 850. Finally, FIG. 62 depicts a graph 860 graphically depicting the impact of adjusting a tuning parameter of an activation function (e.g., tuning parameter 810 of activation function 808), where, in this example, the tuning parameter is set to a value of 0.3. As shown in graph 850, the user thresholds may be used to tune the response of the activation function with respect to specific inputs whereas adjustment of the tuning parameter, as shown in graph 860, has a global effect on the response of the activation function with respect to each of its respective inputs.

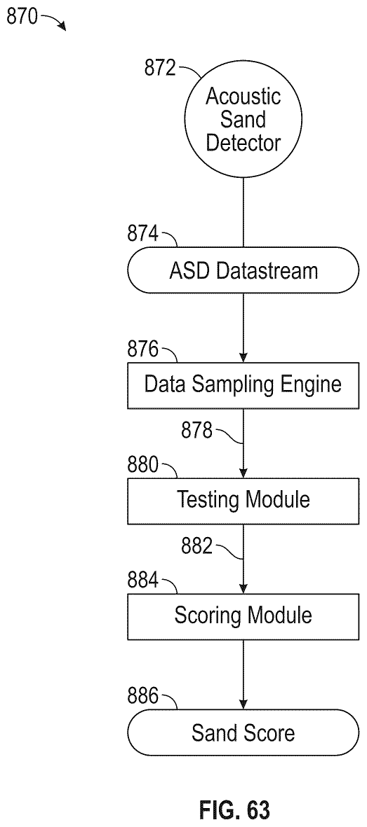

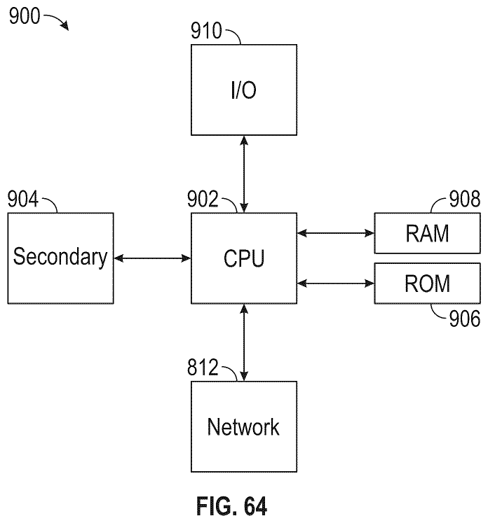

Referring to FIG. 63, another embodiment of a computer-implemented sand detection system 870 is shown. In this exemplary embodiment, sand detection system 870 generally includes one or more ASDs 872 that provide one or more ASD acoustic datastreams 874, a data sampling engine 876, a testing engine or module 880, a scoring engine or module 884 that produces a sand score 886 (e.g., as a time-series function) as an output of the sand detection system 870.

In this exemplary embodiment, the data sampling engine 876 of sand detection system 870 samples and aggregates the different ASD acoustic datastreams 874 received from the ASDs 872. For example, the different ASD acoustic datastreams 874 may have different sampling rates whereby the data sampling engine 876 adjusts the sampling rate of at least some of the ASD acoustic datastreams 874 to provide an aggregated datastream 878. The sampling rate of the aggregated datastream 878 may be less than (e.g., more infrequent) than the sampling rate of at least some of the ASD acoustic datastreams 874 in order to reduce the computational demands on the testing module 880 and scoring module 884 while still providing for real-time or near real-time analysis of the ASD acoustic datastreams 874.

The testing module 880 receives the aggregated datastream 878 provided by data sampling engine 876 and produces one or more test results or scores 882 therefrom. In some embodiments, testing module 880 incorporates the features of sand module 52 and noise module 54 shown in FIG. 1. Alternatively, in other embodiments, testing module 880 may include only a sand module (e.g., sand module 52 shown in FIG. 1) and not a corresponding noise module. Additionally, the scoring module 884 of sand detection system 870 receives the test scores 882 from testing module 880 and produces an overall sand score 886 therefrom. In some embodiments, scoring module 884 is similar in configuration to the scoring module 56 shown in FIG. 1. In certain embodiments, scoring module 884 includes an activation function for determining the sand score 886 like, for example, the activation function 808 shown in FIG. 57. However, the configuration of scoring module 884 may vary in other embodiments.

Referring now to FIG. 63, a computer system 900 suitable for implementing one or more embodiments disclosed herein is shown. Any of the systems and methods disclosed herein can be carried out (e.g., entirely or partially) on a computer or other device comprising a processor (e.g., a desktop computer, a laptop computer, a tablet, a server, a smartphone, or some combination thereof). The computer system 900 includes a processor 902 (which may be referred to as a central processor unit or CPU) that is in communication with memory devices including secondary storage 904, read only memory (ROM) 906, random access memory (RAM) 908, input/output (I/O) devices 910, and network connectivity devices 912. The processor 902 may be implemented as one or more CPU chips.

It is understood that by programming and/or loading executable instructions onto the computer system 900, at least one of the CPUs 902, the RAM 908, and the ROM 906 are changed, transforming the computer system 900 in part into a particular machine or apparatus having the novel functionality taught by the present disclosure. Thus, the RAM 908 and/or the ROM 906 may comprise a non-transitory machine-readable (or computer-readable) medium that may include instructions (which may be referred to herein as machine-readable instructions) that are executable by CPU 902 to provide functionality to computer system 900. Thus, in some embodiments, a machine-readable instructions stored on a memory may be executed on a processor, so as to configured the processor to carry out some or all of the features of the methods described herein.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application specific integrated circuit (ASIC), or field-programmable gate arrays (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 900 is turned on or booted, the CPU 902 may execute a computer program or application. For example, the CPU 902 may execute software or firmware stored in the ROM 906 or stored in the RAM 908. In some cases, on boot and/or when the application is initiated, the CPU 902 may copy the application or portions of the application from the secondary storage 904 to the RAM 908 or to memory space within the CPU 902 itself, and the CPU 902 may then execute instructions of which the application is comprised. In some cases, the CPU 902 may copy the application or portions of the application from memory accessed via the network connectivity devices 912 or via the I/O devices 910 to the RAM 908 or to memory space within the CPU 902, and the CPU 902 may then execute instructions of which the application is comprised. During execution, an application may load instructions into the CPU 902, for example load some of the instructions of the application into a cache of the CPU 902. In some contexts, an application that is executed may be said to configure the CPU 902 to do something, e.g., to configure the CPU 902 to perform the function or functions promoted by the subject application. When the CPU 902 is configured in this way by the application, the CPU 902 becomes a specific purpose computer or a specific purpose machine.

The secondary storage 904 is typically comprised of one or more disk drives or tape drives and is used for non-volatile storage of data and as an over-flow data storage device if RAM 908 is not large enough to hold all working data. Secondary storage 904 may be used to store programs which are loaded into RAM 908 when such programs are selected for execution. The ROM 906 is used to store instructions and perhaps data which are read during program execution. ROM 906 is a non-volatile memory device which typically has a small memory capacity relative to the larger memory capacity of secondary storage 904. The RAM 908 is used to store volatile data and perhaps to store instructions. Access to both ROM 906 and RAM 908 is typically faster than secondary storage 904. The secondary storage 904, the RAM 908, and/or the ROM 906 may be referred to in some contexts as computer readable storage media and/or non-transitory computer readable media.

I/O devices 910 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 912 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 912 may enable the processor 902 to communicate with the Internet or one or more intranets. With such a network connection, it is contemplated that the processor 902 might receive information from the network, or might output information to the network (e.g., to an event database) in the course of performing the methods described herein. Such information, which is often represented as a sequence of instructions to be executed using processor 902, may be received from and outputted to the network, for example, in the form of a computer data signal embodied in a carrier wave.

Such information, which may include data or instructions to be executed using processor 902 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 902 executes instructions, codes, computer programs, scripts which it accesses from hard disk, floppy disk, optical disk, solid state drives (SSD) (these various disk-based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 904, for example, hard drives, floppy disks, optical disks, and/or other device, the ROM 906, and/or the RAM 908 may be referred to in some contexts as non-transitory instructions and/or non-transitory information.

In an embodiment, the computer system 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 900 to provide the functionality of a number of servers that is not directly bound to the number of computers in the computer system 900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 900, at least portions of the contents of the computer program product to the secondary storage 904, to the ROM 906, to the RAM 908, and/or to other non-volatile memory and volatile memory of the computer system 900. The processor 902 may process the executable instructions and/or data structures in part by directly accessing the computer program product, for example by reading from a CD-ROM disk inserted into a disk drive peripheral of the computer system 900. Alternatively, the processor 902 may process the executable instructions and/or data structures by remotely accessing the computer program product, for example by downloading the executable instructions and/or data structures from a remote server through the network connectivity devices 912. The computer program product may comprise instructions that promote the loading and/or copying of data, data structures, files, and/or executable instructions to the secondary storage 904, to the ROM 906, to the RAM 908, and/or to other non-volatile memory and volatile memory of the computer system 900.

In some contexts, the secondary storage 904, the ROM 906, and the RAM 908 may be referred to as a non-transitory computer readable medium or a computer readable storage media. A dynamic RAM embodiment of the RAM 908, likewise, may be referred to as a non-transitory computer readable medium in that while the dynamic RAM receives electrical power and is operated in accordance with its design, for example during a period of time during which the computer system 900 is turned on and operational, the dynamic RAM stores information that is written to it. Similarly, the processor 902 may comprise an internal RAM, an internal ROM, a cache memory, and/or other internal non-transitory storage blocks, sections, or components that may be referred to in some contexts as non-transitory computer readable media or computer readable storage media. At least some, if not all, of the steps or “blocks” of the methods described herein (e.g., methods 80, 190, 260, 350, 430, 500, 610, and/or 700), as well as the functionalities of the sand detection systems (e.g., systems 50, 800 and/or 870) may be executed by the computer system 900 shown in FIG. 63.

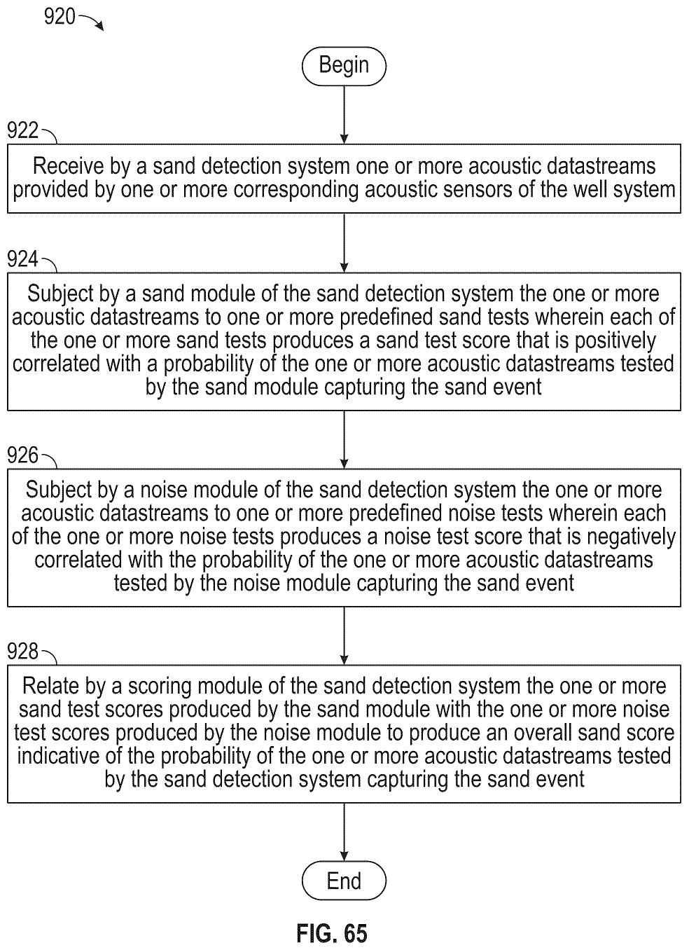

Referring to FIG. 65, an embodiment of a method 920 for detecting a sand event in a well system (e.g., well system 10 shown in FIG. 1) is shown. Initially, at block 922, method 920 includes receiving by a sand detection system (e.g., sand detection systems 50, 800, and 870 shown in FIGS. 1, 57, and 63, respectively) one or more acoustic datastreams (e.g., ASD acoustic datastreams 874 shown in FIG. 63) provided by one or more corresponding acoustic sensors (e.g., ASDs 40 shown in FIG. 1) of the well system. At block 924, method 920 includes subjecting by a sand module (e.g., sand module 52 shown in FIG. 1) of the sand detection system the one or more acoustic datastreams to one or more predefined sand tests (e.g., sand tests 802 shown in FIG. 57) wherein each of the one or more sand tests produces a sand test score (e.g., sand test scores 803 shown in FIG. 57) that is positively correlated with a probability of the one or more acoustic datastreams tested by the sand module capturing the sand event.

At block 926, method 920 includes subjecting by a noise module (e.g., noise module 54 shown in FIG. 1) of the sand detection system the one or more acoustic datastreams to one or more predefined noise tests (e.g., noise tests 804 shown in FIG. 57) wherein each of the one or more noise tests produces a noise test score (e.g., noise test scores 805 shown in FIG. 57) that is negatively correlated with the probability of the one or more acoustic datastreams tested by the noise module capturing the sand event. At block 928, method 920 includes relating by a scoring module (e.g., scoring modules 56 and 884 shown in FIGS. 1 and 63, respectively) of the sand detection system the one or more sand test scores produced by the sand module with the one or more noise test scores produced by the noise module to produce an overall sand score (e.g., overall sand score 886 shown in FIG. 63) indicative of the probability of the one or more acoustic datastreams tested by the sand detection system capturing the sand event.

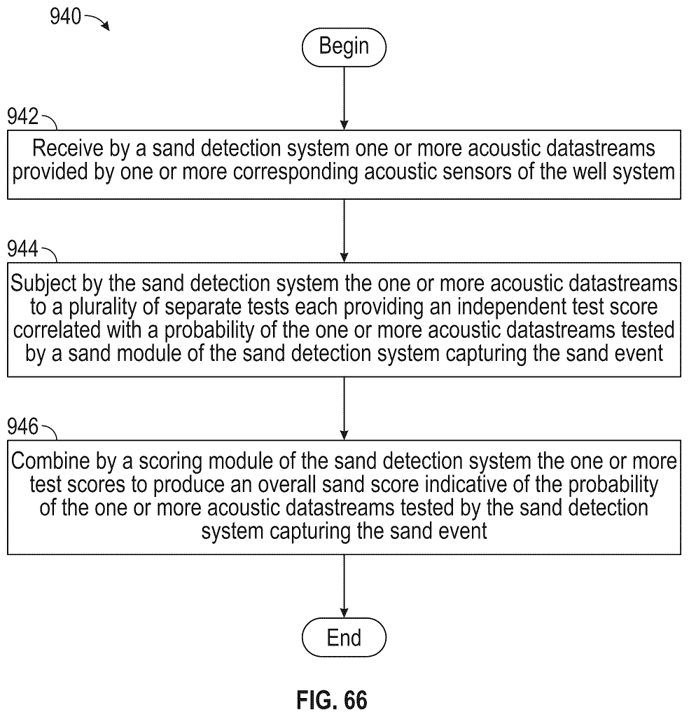

Referring to FIG. 66, another embodiment of a method 940 for detecting a sand event in a well system (e.g., well system 10 shown in FIG. 1) is shown. Initially, at block 942, method 940 includes receiving by a sand detection system (e.g., sand detection systems 50, 800, and 870 shown in FIGS. 1, 57, and 63, respectively) one or more acoustic datastreams (e.g., ASD acoustic datastreams 874 shown in FIG. 63) provided by one or more corresponding acoustic sensors (e.g., ASDs 40 shown in FIG. 1) of the well system.

At block 944, method 940 includes subjecting by the sand detection system the one or more acoustic datastreams to a plurality of separate tests (e.g., sand tests 802 shown in FIG. 57) each providing an independent test score (e.g., sand test scores 803 shown in FIG. 57) correlated with a probability of the one or more acoustic datastreams tested by a sand module of the sand detection system capturing the sand event. At block 946, method 940 includes combining by a scoring module (e.g., scoring modules 56 and 884 shown in FIGS. 1 and 63, respectively) of the sand detection system the one or more test scores to produce an overall sand score (e.g., overall sand score 886 shown in FIG. 63) indicative of the probability of the one or more acoustic datastreams tested by the sand detection system capturing the sand event.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for detecting a sand event in a well system, the method comprising:
(a) receiving by a sand detection system one or more acoustic datastreams provided by one or more corresponding acoustic sensors of the well system;
(b) subjecting by a sand module of the sand detection system the one or more acoustic datastreams to one or more predefined sand tests wherein each of the one or more sand tests produces a sand test score that is positively correlated with a probability of the one or more acoustic datastreams tested by the sand module capturing the sand event;
(c) subjecting by a noise module of the sand detection system the one or more acoustic datastreams to one or more predefined noise tests wherein each of the one or more noise tests produces a noise test score that is negatively correlated with the probability of the one or more acoustic datastreams tested by the noise module capturing the sand event; and
(d) relating by a scoring module of the sand detection system the one or more sand test scores produced by the sand module with the one or more noise test scores produced by the noise module to produce an overall sand score indicative of the probability of the one or more acoustic datastreams tested by the sand detection system capturing the sand event.

2. The method of claim 1, wherein (d) comprises inputting the one or more sand test scores and the one or more noise test scores to an activation function that produces as an output the overall sand score.

3. The method of claim 1, wherein:
each of the one or more sand tests are indicative of the occurrence of the sand event in the one or more acoustic datastreams tested by the sand module; and
each of the one or more noise tests are indicative of one or more noise events in the one or more acoustic datastreams tested by the noise module.

4. The method of claim 1, wherein the one or more sand tests comprises at least one of an anomaly detection test and a positive skew detection test.

5. The method of claim 1, wherein (d) comprises inputting the one or more sand test scores to an activation function that produces as an output the overall sand score.

6. The method of claim 1, wherein the one or more noise tests comprises at least one of a baseline jump detection test, a data fitness test, a homogeneity detection test, a bimodal test, a well similarity detection test, and a choke stability test.

7. The method of claim 6, wherein the baseline jump detection test produces a baseline jump score that is based on a sequential modality and a post-jump stability of the one or more acoustic datastreams tested by the noise module.

8. The method of claim 6, wherein the data fitness test produces a data fitness score that is based on missing values within the one or more acoustic datastreams tested by the noise module.

9. A method for detecting a sand event in a well system, the method comprising:
(a) receiving by a sand detection system one or more acoustic datastreams, wherein the one or more acoustic datastreams are provided by one or more corresponding acoustic sensors of the well system;
(b) subjecting by the sand detection system the one or more acoustic datastreams to a plurality of separate tests each providing an independent test score correlated with a probability of the one or more acoustic datastreams tested by a sand module of the sand detection system capturing the sand event; and
(c) combining by a scoring module of the sand detection system the one or more test scores to produce an overall sand score indicative of the probability of the one or more acoustic datastreams tested by the sand detection system capturing the sand event.

10. The method of claim 9, wherein (c) comprises inputting the one or more test scores to an activation function that produces as an output the overall sand score.

11. The method of claim 9, wherein the one or more tests comprises at least one of an anomaly detection test and a positive skew detection test.

12. The method of claim 11, wherein the anomaly detection test produces an anomaly score that is based on a comparison between a selected window of the one or more acoustic datastreams and a baseline of the one or more acoustic datastreams.

13. The method of claim 12, wherein the positive skew detection test produces a skew score that is based on a relationship between a spike and a decay of a selected window of the one or more acoustic datastreams.

14. The method of claim 13, wherein (c) comprises inputting the anomaly score and the positive skew score to an activation function that produces as an output the overall sand score.

15. The method of claim 9, wherein the one or more tests comprises at least one of a baseline jump detection test, a data fitness test, a homogeneity detection test, a bimodal test, a well similarity detection test, and a choke stability test.

16. The method of claim 15, wherein the homogeneity detection test produces a homogeneity similarity score that is based on a frequency spectrum of a Fourier transformed datastream obtained from the one or more acoustic datastreams.

17. The method of claim 15, wherein the bimodal test produces a bimodal score that is based on the magnitude of a difference between at least one of an upper quartile of the one or more acoustic datastreams and a baseline of the one or more acoustic datastreams, the baseline and a lower quartile of the one or more acoustic datastreams, and the upper quartile and the lower quartile.

18. The method of claim 15, wherein the well similarity detection test produces a neighboring well similarity score that is based on a similarity between the one or more acoustic datastreams and one or more neighboring acoustic datastreams of one or more neighboring wellsites that are time-synced with the one or more acoustic datastreams.

19. The method of claim 15, wherein the choke stability test produces a choke stability score that is based on a comparison between the one or more acoustic datastreams and a choke position datastream provided by a choke position sensor of the well system.

20. A system, comprising:
one or more processors; and
one or more storage devices coupled to the one or more processors, the one or more storage devices configured to store instructions that, when executed by the one or more processors, configure the one or more processors to:
(a) receive by a sand detection system one or more acoustic datastreams, wherein the one or more acoustic datastreams are provided by one or more corresponding acoustic sensors of a well system;
(b) subject by the sand detection system the one or more acoustic datastreams to a plurality of separate tests each providing an independent test score correlated with a probability of the one or more acoustic datastreams tested by a sand module of the sand detection system capturing a sand event; and
(c) combine by a scoring module of the sand detection system the one or more test scores to produce an overall sand score indicative of the probability of the one or more acoustic datastreams tested by the sand detection system capturing the sand event.
